(19) United States
(12) Patent Application Publication
(10) Pub. No.: US 2025/0299883 A1
(43) Pub. Date: Sep. 25, 2025

(54) MULTILAYER CERAMIC ELECTRONIC COMPONENT

(71) Applicant: Murata Manufacturing Co., Ltd., Nagaokakyo-shi (JP)

(72) Inventor: Haruki OOGUCHI, Nagaokakyo-shi (JP)

(21) Appl. No.: 19/079,549

(22) Filed: Mar. 14, 2025

(30) Foreign Application Priority Data
Mar. 22, 2024 (JP) 2024-046276

(51) Int. Cl. H01G 4/232; H01G 4/30

(52) U.S. Cl. CPC H01G 4/232; H01G 4/30

(57) ABSTRACT

Multilayer ceramic electronic components that are each able to improve deflection resistance are provided. The multilayer ceramic electronic components each include a multilayer body including internal electrode layers, and a pair of external electrodes respectively provided on both end portions of the multilayer body. Each of the pair of electrode layers includes a main surface-side external electrode. The main surface-side external electrode includes a surface opposed to a main surface. The surface includes a stepped portion that, in a height from the main surface to the surface, makes a height of the surface located adjacent to a middle of the multilayer body in a length direction lower than the surface located adjacent to an outer side of the multilayer body in the length direction. The stepped portion includes a curved shape protruding toward the middle in the length direction, and extends in a width direction on the surface.

### CROSS REFERENCE TO RELATED APPLICATIONS

This application claims the benefit of priority to Japanese Patent Application No. 2024-046276 filed on Mar. 22, 2024. The entire contents of this application are hereby incorporated herein by reference.

### BACKGROUND OF THE INVENTION

### 1. Field of the Invention

The present invention relates to a multilayer ceramic electronic component.

### 2. Description of the Related Art

In the prior art, multilayer ceramic capacitors have been known as multilayer ceramic electronic components. In general, multilayer ceramic capacitors each include a multilayer body in which a plurality of dielectric layers and a plurality of internal electrode layers are alternately laminated, and external electrodes which are provided on both end surfaces of the multilayer body. For example, Japanese Unexamined Patent Application, Publication No. 2003-243249 discloses a multilayer ceramic capacitor including the above-described configuration and external electrodes each including a base electrode layer formed by firing.

### SUMMARY OF THE INVENTION

Incidentally, in this type of multilayer ceramic capacitor, there is a concern that a crack or the like may occur in the multilayer body due to a deflection stress generated in the external electrode being transmitted to the multilayer body when the multilayer ceramic capacitor is mounted on a substrate or the like. Therefore, there is a need for multilayer ceramic capacitors each including improved deflection resistance.

Example embodiments of the present invention provide multilayer ceramic electronic components that are each able to improve deflection resistance.

An example embodiment of the present invention provides multilayer ceramic electronic components that each include: a multilayer body including a plurality of ceramic layers and a plurality of internal conductive layers alternately laminated in a height direction, a pair of main surfaces opposed to each other in the height direction, a pair of end surfaces opposed to each other in a length direction orthogonal or substantially orthogonal to the height direction, and a pair of lateral surfaces opposed to each other in a width direction orthogonal or substantially orthogonal to the height direction and the length direction; and a pair of external electrodes that are each provided on a corresponding one of both end portions in the length direction of the multilayer body in a manner spaced from each other, in which the pair of main surfaces includes a first main surface and a second main surface opposed to each other in the height direction, the pair of end surfaces includes a first end surface and a second end surface opposed to each other in the length direction, the pair of lateral surfaces includes a first lateral surface and a second lateral surface opposed to each other in the width direction, the plurality of internal conductive layers include a plurality of first internal conductive layers that extend toward and are exposed at the first end surface and a plurality of second internal conductive layers that extend toward and are exposed at the second end surface, each of the pair of external electrodes includes a main surface-side external electrode on at least one of the first main surface or the second main surface, the main surface-side external electrode includes a surface opposed to the at least one of the first main surface or the second main surface, the surface includes a stepped portion that, in a height from the at least one of the first main surface or the second main surface to the surface, makes a height of the surface located adjacent to a middle of the multilayer body in the length direction lower than the surface located adjacent to an outer side of the multilayer body in the length direction, and the stepped portion includes a curved shape protruding toward the middle in the length direction, and extends in the width direction on the surface.

According to an example embodiment of the present invention, it is possible to provide multilayer ceramic electronic components that are each able to improve deflection resistance.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1A is an external perspective view of a multilayer ceramic capacitor according to an example embodiment of the present invention.

FIG. 1B is a view taken in the direction of the arrow IB in FIG. 1A.

FIG. 1C is a view taken in the direction of the arrow IC in FIG. 1A.

FIG. 2 is a cross-sectional view taken along the line II-II in FIGS. 1A and 1B.

FIG. 3 is a cross-sectional view taken along the line III-III in FIGS. 1C and 2.

FIG. 4 is a cross-sectional view taken along the line IV-IV in FIGS. 1C and 2.

FIG. 5 is an enlarged view of a portion indicated by V in FIG. 2, showing a cross section of a first main surface-side external electrode.

FIG. 6A is a diagram showing a method of manufacturing a multilayer ceramic capacitor according to an example embodiment, and showing a first step of forming an external electrode on a multilayer body.

FIG. 6B is a diagram showing a method of manufacturing the multilayer ceramic capacitor according to the example embodiment, and showing a second step of forming the external electrode on the multilayer body.

FIG. 7A is a diagram showing a multilayer ceramic capacitor including a two-portion configuration.

FIG. 7B is a diagram showing a multilayer ceramic capacitor including a three-portion configuration.

FIG. 7C is a diagram showing a multilayer ceramic capacitor including a four-portion configuration.

### DETAILED DESCRIPTION OF THE EXAMPLE EMBODIMENTS

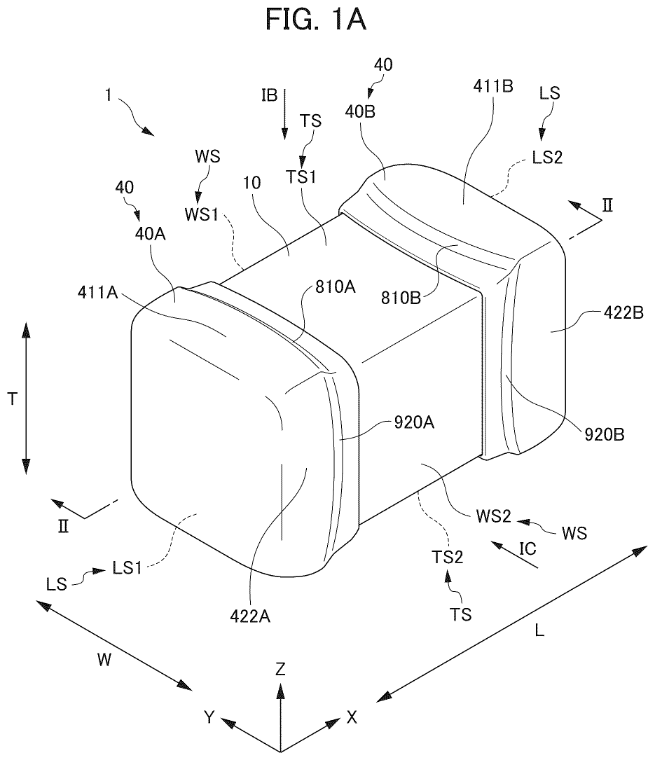

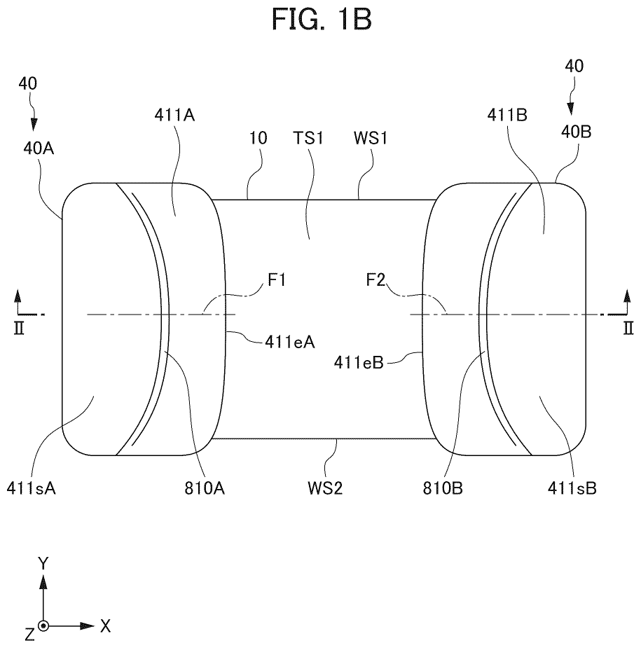

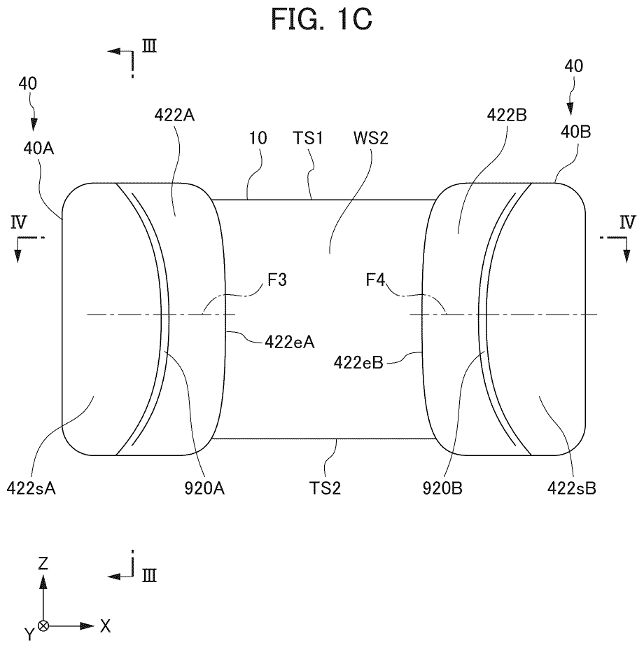

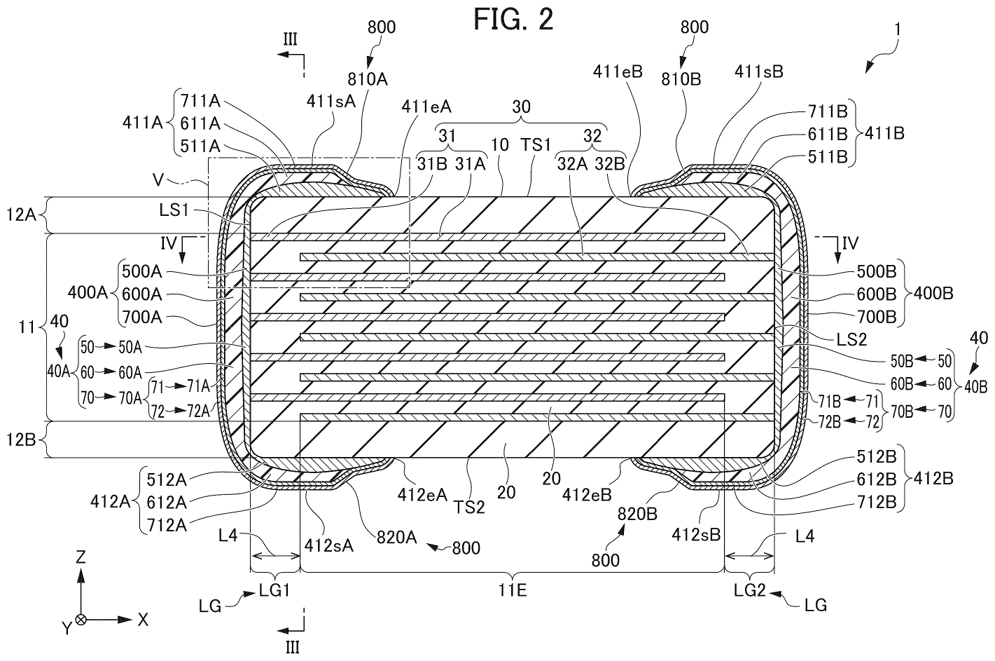

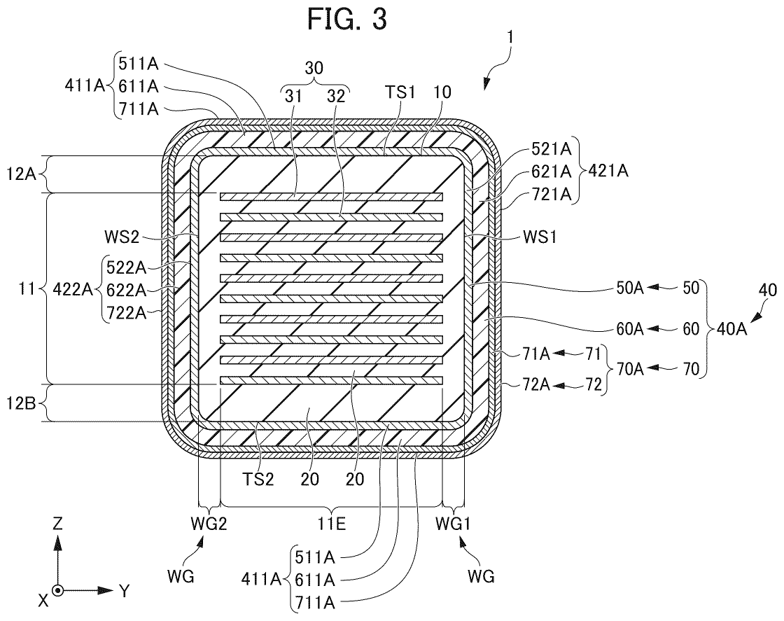

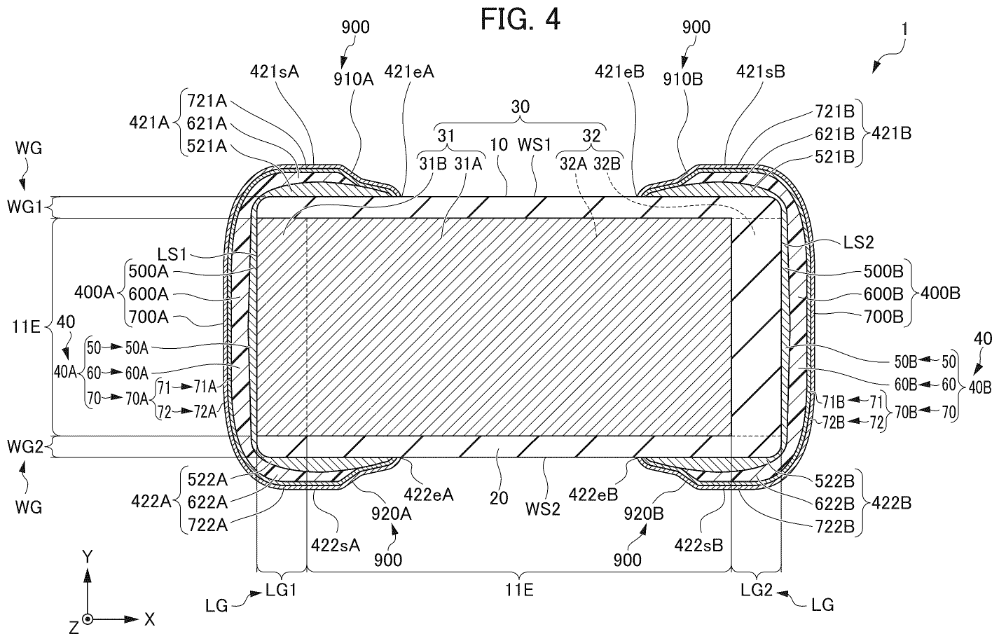

Hereinafter, a multilayer ceramic capacitor 1 as a multilayer ceramic electronic component according to an example embodiment will be described with reference to FIGS. 1A to 4. FIG. 1A is an external perspective view of a multilayer ceramic capacitor 1 according to an example embodiment. FIG. 1B is a view taken in the direction of the arrow IB in FIG. 1A. FIG. 1C is a view in the direction of the arrow IC in FIG. 1A. FIG. 2 is a cross-sectional view taken along the line II-II in FIGS. 1A and 1B. FIG. 3 is a cross-sectional view taken along the line III-III in FIGS. 1C and 2. FIG. 4 is a cross-sectional view taken along the line IV-IV in FIGS. 1C and 2.

The multilayer ceramic capacitor 1 includes a multilayer body 10 and external electrodes 40.

FIGS. 1A to 4 each show an XYZ orthogonal coordinate system. The length direction L of each of the multilayer ceramic capacitor 1 and the multilayer body 10 corresponds to the X direction. The width direction W of each of the multilayer ceramic capacitor 1 and the multilayer body 10 corresponds to the Y direction. The lamination (stacking) direction T as the height direction of each of the multilayer ceramic capacitor 1 and the multilayer body 10 corresponds to the Z direction. Here, the cross section shown in FIG. 2 is also referred to as an LT cross section. The cross section shown in FIG. 3 is also referred to as a WT cross section. The cross section shown in FIG. 4 is also referred to as an LW cross section.

As shown in FIG. 1A, the multilayer body 10 includes a pair of main surfaces TS opposed to each other in the lamination direction T, a pair of end surfaces LS opposed to each other in a length direction L orthogonal or substantially orthogonal to the lamination direction T, and a pair of lateral surfaces WS opposed to each other in a width direction W orthogonal or substantially orthogonal to the lamination direction T and the length direction L. The main surfaces TS include a first main surface TS1 and a second main surface TS2 opposite to each other in the lamination direction T. The end surfaces LS include a first end surface LS1 and a second end surface LS2 opposite to each other in the length direction L. The lateral surfaces WS include a first lateral surface WS1 and a second lateral surface WS2 opposite to each other in the width direction W.

As shown in FIGS. 1A to 1C, the multilayer body 10 has a substantially rectangular parallelepiped shape. The dimension of the multilayer body 10 in the length direction L is not necessarily longer than the dimension in the width direction W. The corner portions and ridge portions of the multilayer body 10 are preferably rounded. Each of the corner portions is a portion where the three surfaces of the multilayer body 10 intersect, and each of the ridge portions is a portion where the two surfaces of the multilayer body 10 intersect. In addition, unevenness or the like may be provided on a portion or the entirety of the surface of the multilayer body 10.

The dimension of the multilayer body 10 is not particularly limited, but when the dimension in the length direction L of the multilayer body 10 is defined as an L dimension, the L dimension is preferably 0.2 mm or more and 10 mm or less. When the dimension of the multilayer body 10 in the lamination direction T is defined as a T dimension, the T dimension is preferably 0.1 mm or more and 10 mm or less. When the dimension of the multilayer body 10 in the width direction W is defined as a W direction, the dimension W is preferably 0.1 mm or more and 10 mm or less.

As shown in FIGS. 2 and 3, the multilayer body 10 includes an inner layer portion 11, and a first main surface-side outer layer portion 12A functioning as a first outer layer portion and a second main surface-side outer layer portion 12B functioning as a second outer layer portion sandwiching the inner layer portion 11 in the lamination direction T.

The inner layer portion 11 includes a plurality of dielectric layers 20 functioning as a plurality of ceramic layers and a plurality of internal electrode layers 30 functioning as a plurality of internal conductive layers. The inner layer portion 11 includes an internal electrode layer 30 positioned closest to the first main surface TS1 to an internal electrode layer 30 positioned closest to the second main surface TS2 in the lamination direction T. In the inner layer portion 11, the plurality of internal electrode layers 30 are opposed to each other with each of the plurality of dielectric layers 20 interposed therebetween. The inner layer portion 11 is a portion that substantially functions as a capacitor for generating capacitance.

The plurality of dielectric layers 20 are made of a dielectric material. The dielectric material may be, for example, a dielectric ceramic containing components such as BaTiO₃, CaTiO₃, SrTiO₃, or CaZro₃. Further, the dielectric material may be a material obtained by adding subcomponents such as Mn compound, Fe compound, Cr compound, Co compound, and Ni compound to these main components.

The thickness of each of the plurality of dielectric layers 20 is preferably 0.5 μm or more and 30 μm or less. The number of laminated dielectric layers 20 is preferably 10 or more and 1500 or less. The number of dielectric layers 20 is a total number of the number of dielectric layers of the inner layer portion 11 and the number of dielectric layers of the first main surface-side outer layer portion 12A and the second main surface-side outer layer portion 12B.

The plurality of internal electrode layers 30 includes first internal electrode layers 31 functioning as a plurality of first internal conductive layers and second internal electrode layers 32 functioning as a plurality of second internal conductive layers. The plurality of first internal electrode layers 31 are provided on the plurality of dielectric layers 20. The plurality of second internal electrode layers 32 are provided on the plurality of dielectric layers 20. The plurality of first internal electrode layers 31 and the plurality of second internal electrode layers 32 are alternately provided with each of the plurality of dielectric layers 20 interposed therebetween in the lamination direction T of the multilayer body 10. One of the first internal electrode layers 31 and one of the second internal electrode layers 32 sandwich one of the dielectric layers 20. In the following description, when it is not necessary to distinguish between the first internal electrode layer 31 and the second internal electrode layer 32, the first internal electrode layer 31 and the second internal electrode layer 32 may be collectively referred to as the internal electrode layer 30.

Each of the plurality of first internal electrode layers 31 includes a first counter portion 31A opposed to each of the plurality of second internal electrode layers 32, and a first extension portion 31B extending from the first counter portion 31A toward the first end surface LS1. The first extension portion 31B is exposed at the first end surface LS1.

Each of the plurality of second internal electrode layers 32 includes a second counter portion 32A opposed to each of the plurality of first internal electrode layers 31, and a second extension portion 32B extending from the second counter portion 32A toward the second end surface LS2. The second extension portion 32B is exposed at the second end surface LS2.

In the present example embodiment, the first counter portion 31A and the second counter portion 32A are opposed to each other with the dielectric layer 20 interposed therebetween, such that a capacitance is generated, and the characteristics of the capacitor are developed.

The shapes of each of the first counter portions 31A and each of the second counter portions 32A are not particularly limited, but are preferably rectangular. However, each of the corner portions of the rectangular shape may be rounded, or each of the corner portions of the rectangular shape may include an oblique portion. The shapes of each of the plurality of first extension portions 31B and each of the plurality of second extension portions 32B are not particularly limited, but are preferably rectangular. However, each of the corner portions of the rectangular shape may be rounded, or each of the corner portions of the rectangular shape may include an oblique portion.

The dimension of each of the plurality of first counter portions 31A in the width direction W and the dimension of each of the plurality of first extension portions 31B in the width direction W may be the same, or either one of them may be smaller. The dimension of each of the plurality of second counter portions 32A in the width direction W and the dimension of each of the plurality of second extension portions 32B in the width direction W may be the same, or either one of them may be narrower.

Each of the plurality of first internal electrode layers 31 and each of the plurality of second internal electrode layers 32 are made of an appropriate electrically conductive material such as a metal such as Ni, Cu, Ag, Pd, or Au, or an alloy containing at least one of these metals. When an alloy is used, each of the plurality of first internal electrode layers 31 and each of the plurality of second internal electrode layers 32 may be made of, for example, an Ag—Pd alloy.

Each of the thicknesses of the plurality of first internal electrode layers 31 and the plurality of second internal electrode layers 32 are preferably, for example, about 0.2 μm or more and 2.0 μm or less. The total number of the plurality of first internal electrode layers 31 and the plurality of second internal electrode layers 32 is preferably 10 or more and 1500 or less.

The first main surface-side outer layer portion 12A is positioned adjacent to the first main surface TS1 of the multilayer body 10. The first main surface-side outer layer portion 12A is an aggregate of a plurality of dielectric layers 20 positioned between the first main surface TS1 and the internal electrode layer 30 closest to the first main surface TS1. The dielectric layers 20 in the first main surface-side outer layer portion 12A may be the same as the dielectric layers 20 in the inner layer portion 11, or may be dielectric layers made of a different material.

The second main surface-side outer layer portion 12B is positioned adjacent to the second main surface TS2 of the multilayer body 10. The second main surface-side outer layer portion 12B is an aggregate of a plurality of dielectric layers 20 positioned between the second main surface TS2 and the internal electrode layer 30 closest to the second main surface TS2. The dielectric layers 20 in the second main surface-side outer layer portion 12B may be the same as the dielectric layers 20 in the inner layer portion 11, or may be a dielectric layer made of a different material.

The multilayer body 10 includes a counter electrode portion 11E. The counter electrode portion 11E is a portion where the first counter portions 31A of the first internal electrode layers 31 and the second counter portions 32A of the second internal electrode layers 32 are opposed to each other. The counter electrode portion 11E is a portion of the inner layer portion 11. FIG. 4 shows the range in the width direction W and the length direction L of the counter electrode portion 11E. The counter electrode portion 11E is also referred to as a capacitor effective portion.

The multilayer body 10 includes lateral surface-side outer layer portions WG. The lateral surface-side outer layer portions WG include a first lateral surface-side outer layer portion WG1 and a second lateral surface-side outer layer portion WG2. The first lateral surface-side outer layer portion WG1 is a portion including the dielectric layers 20 positioned between the counter electrode portion 11E and the first lateral surface WS1. The second lateral surface-side outer layer portion WG2 is a portion including the dielectric layers 20 positioned between the counter electrode portion 11E and the second lateral surface WS2. FIGS. 3 and 4 each show the ranges in the width direction W of the first lateral surface-side outer layer portion WG1 and the second lateral surface-side outer layer portion WG2. The lateral surface-side outer layer portions are also each referred to as a W gap or a side gap.

The multilayer body 10 includes end surface-side outer layer portions LG. The end surface-side outer layer portions LG include a first end surface-side outer layer portion LG1 and a second end surface-side outer layer portion LG2. The first end surface-side outer layer portion LG1 is a portion including the dielectric layers 20 positioned between the counter electrode portion 11E and the first end surface LS1. The second end surface-side outer layer portion LG2 is a portion including the dielectric layers 20 positioned between the counter electrode portion 11E and the second end surface LS2. FIGS. 2 and 4 each show a range in the length direction L of the first end surface-side outer layer portion LG1 and the second end surface-side outer layer portion LG2. The end surface-side outer layer portions are also each referred to as an L gap or an end gap.

The external electrodes 40 include a first external electrode 40A on and adjacent to the first end surface LS1 and a second external electrode 40B on and adjacent to the second end surface LS2.

The first external electrode 40A is provided on the first end surface LS1. The first external electrode 40A is connected to the first internal electrode layers 31. The first external electrode 40A is provided on a portion of the first main surface TS1 and a portion of the second main surface TS2. In the example embodiment, the first external electrode 40A extends from the first end surface LS1 to a portion of the first main surface TS1 and a portion of the second main surface TS2, and a portion of the first lateral surface WS1 and a portion of the second lateral surface WS2.

The second external electrode 40B is provided on the second end surface LS2. The second external electrode 40B is connected to the second internal electrode layers 32. The second external electrode 40B is provided on a portion of the first main surface TS1 and a portion of the second main surface TS2. In the example embodiment, the second external electrode 40B extends from the second end surface LS2 to a portion of the first main surface TS1 and a portion of the second main surface TS2, and a portion of the first lateral surface WS1 and a portion of the second lateral surface WS2.

As described above, in the multilayer body 10, the first counter portions 31A of the first internal electrode layers 31 and the second counter portions 32A of the second internal electrode layers 32 are opposed to each other with each of the dielectric layers 20 interposed therebetween, such that a capacitance is generated. Therefore, the characteristic of the capacitor is developed between the first external electrode 40A to which the first internal electrode layers 31 are connected and the second external electrode 40B to which the second internal electrode layers 32 are connected.

The first external electrode 40A includes a first base electrode layer 50A including a metal component, a first electrically conductive resin layer 60A provided on the first base electrode layer 50A, and a first plated layer 70A provided on the first electrically conductive resin layer 60A. The first plated layer 70A includes a first Ni plated layer 71A and a first Sn plated layer 72A.

The second external electrode 40B includes a second base electrode layer 50B including a metal component, a second electrically conductive resin layer 60B provided on the second base electrode layer 50B, and a second plated layer 70B provided on the second electrically conductive resin layer 60B. The second plated layer 70B includes a second Ni plated layer 71B and a second Sn plated layer 72B.

Here, the basic configuration of the respective layers of the first external electrode 40A and the second external electrode 40B are the same. The first external electrode 40A and the second external electrode 40B are substantially plane symmetrical with respect to the LW cross section in the middle of the length direction L of the multilayer ceramic capacitor 1. Therefore, in a case where it is not necessary to particularly distinguish between the first external electrode 40A and the second external electrode 40B, the first external electrode 40A and the second external electrode 40B may be collectively referred to as an external electrode 40. When it is not necessary to particularly distinguish between the first base electrode layer 50A and the second base electrode layer 50B, the first base electrode layer 50A and the second base electrode layer 50B are collectively referred to as a base electrode layer 50. When it is not necessary to particularly distinguish between the first electrically conductive resin layer 60A and the second electrically conductive resin layer 60B, the first electrically conductive resin layer 60A and the second electrically conductive resin layer 60B may be collectively referred to as an electrically conductive resin layer 60. When it is not necessary to particularly distinguish between the first plated layer 70A and the second plated layer 70B, the first plated layer 70A and the second plated layer 70B may be collectively referred to as a plated layer 70. When it is not necessary to particularly distinguish between the first Ni plated layer 71A and the second Ni plated layer 71B, the first Ni plated layer 71A and the second Ni plated layer 71B may be collectively referred to as a Ni plated layer 71. When it is not necessary to particularly distinguish between the first Sn plated layer 72A and the second Sn plated layer 72B, the first Sn plated layer 72A and the second Sn plated layer 72B may be collectively referred to as the Sn plated layer 72.

The base electrode layer 50 includes a first base electrode layer 50A and a second base electrode layer 50B.

The first base electrode layer 50A is provided on the first end surface LS1. The first base electrode layer 50A is connected to the first internal electrode layers 31. In the example embodiment, the first base electrode layer 50A extends from the first end surface LS1 to a portion of the first main surface TS1 and a portion of the second main surface TS2, and a portion of the first lateral surface WS1 and a portion of the second lateral surface WS2.

The second base electrode layer 50B is provided on the second end surface LS2. The second base electrode layer 50B is connected to the second internal electrode layers 32. In the example embodiment, the second base electrode layer 50B extends from the second end surface LS2 to a portion of the first main surface TS1 and a portion of the second main surface TS2, and a portion of the first lateral surface WS1 and a portion of the second lateral surface WS2.

The first base electrode layer 50A and the second base electrode layer 50B of the example embodiment are fired layers. The fired layers each preferably contains a metal component and either or both of a glass component and a ceramic component. Thus, the adhesion between the multilayer body 10 and the base electrode layer can be improved. The metal component includes, for example, at least one selected from Cu, Ni, Ag, Pd, Ag—Pd alloy, Au, and the like. The glass component includes, for example, at least one selected from B, Si, Ba, Mg, Al, Li, and the like. When a glass component is present, sintering of the metal component in the base electrode layer can be promoted and advanced. The ceramic component may be a ceramic material of the same kind as the dielectric layer 20 or a ceramic material of a different kind. The ceramic component includes, for example, at least one selected from BaTiO₃, CaTio₃, (Ba, Ca)TiO₃, SrTiO₃, CaZrO₃, and the like.

The fired layer is formed, for example, by coating a multilayer body with an electrically conductive paste containing glass and metal and firing the resulting product. The fired layer may be obtained by simultaneously firing a multilayer chip having internal electrode layers and dielectric layers and an electrically conductive paste applied to the multilayer chip, or may be obtained by firing a multilayer chip having internal electrode layers and dielectric layers to obtain a multilayer body, and then firing the multilayer body by applying the electrically conductive paste to the multilayer body. In a case where the multilayer chip having the internal electrode layers and the dielectric layers, and the electrically conductive paste applied to the multilayer chip are simultaneously fired, the fired layer including a ceramic material instead of the glass component is preferably formed. In this case, it is particularly preferable to use the same kind of ceramic material as the dielectric layer 20 as the ceramic material to be added. The fired layer may include a plurality of layers.

The thickness in the length direction L of the first base electrode layer 50A located at the first end surface LS1 is preferably, for example, about 2 μm or more and 220 μm or less in the middle of the first base electrode layer 50A in the lamination direction T and the width direction W.

The thickness in the length direction L of the second base electrode layer 50B located at the second end surface LS2 is preferably, for example, about 2 μm or more and 220 μm or less in the middle of the second base electrode layer 50B in the lamination direction T and the width direction W.

In a case where the first base electrode layer 50A is provided also on a portion of at least one surface of the first main surface TS1 or the second main surface TS2, the thickness of the first base electrode layer 50A provided on this portion in the lamination direction T is preferably, for example, about 3 μm or more and 40 μm or less in the middle in the length direction L and the width direction W of the first base electrode layer 50A provided on this portion.

In a case where the first base electrode layer 50A is provided also on a portion of at least one of the first lateral surface WS1 and the second lateral surface WS2, the thickness in the width direction of the first base electrode layer 50A provided on this portion is preferably, for example, about 3 μm or more and 40 μm or less in the middle in the length direction L and the lamination direction T of the first base electrode layer 50A provided on this portion.

In a case where the second base electrode layer 50B is provided on a portion of at least one surface of the first main surface TS1 or the second main surface TS2, the thickness of the second base electrode layer 50B provided on this portion in the lamination direction T is preferably, for example, about 3 μm or more and 40 μm or less in the middle in the length direction L and the width direction W of the second base electrode layer 50B provided on this portion.

In a case where the second base electrode layer 50B is provided also on a portion of at least one of the first lateral surface WS1 and the second lateral surface WS2, the thickness in the width direction of the second base electrode layer 50B provided on this portion is preferably, for example, about 3 μm or more and 40 μm or less in the middle in the length direction L and the lamination direction T of the second base electrode layer 50B provided on this portion.

Each of the external electrodes 40 includes an electrically conductive resin layer 60 containing a resin component and a metal component provided on the base electrode layer 50.

The electrically conductive resin layer 60 includes a first electrically conductive resin layer 60A and a second electrically conductive resin layer 60B.

The first electrically conductive resin layer 60A covers the first base electrode layer 50A. In the example embodiment, the first electrically conductive resin layer 60A extends from the first end surface LS1 to a portion of the first main surface TS1 and a portion of the second main surface TS2, and a portion of the first lateral surface WS1 and a portion of the second lateral surface WS2. The second electrically conductive resin layer 60B covers the second base electrode layer 50B. In the example embodiment, the second electrically conductive resin layer 60B extends from the second end surface LS2 to a portion of the first main surface TS1 and a portion of the second main surface TS2, and a portion of the first lateral surface WS1 and a portion of the second lateral surface WS2. Here, the dimension in the length direction L on each of the first main surface TS1 and the second main surface TS2 of the first electrically conductive resin layer 60A is shorter than the dimension in the length direction L on each of the first main surface TS1 and the second main surface TS2 of the first base electrode layer 50A. Further, the dimension of the second electrically conductive resin layer 60B in the length direction L on each of the first main surface TS1 and the second main surface TS2 is shorter than the dimension in the length direction L on each of the first main surface TS1 and the second main surface TS2 of the second base electrode layer 50B.

The thickness in the length direction L of the first electrically conductive resin layer 60A positioned adjacent to the first end surface LS1 is preferably, for example, about 5 μm or more and 200 μm or less in the middle of the first electrically conductive resin layer 60A in the lamination direction T and the width direction W.

The thickness in the length direction L of the second electrically conductive resin layer 60B positioned adjacent to the second end surface LS2 is preferably, for example, about 5 μm or more and 200 μm or less in the middle of the second electrically conductive resin layer 60B in the lamination direction T and the width direction W.

In a case where the first electrically conductive resin layer 60A is also provided on a portion of the first main surface TS1 and a portion of the second main surface TS2, the thickness in the lamination direction T of the first electrically conductive resin layer 60A provided on this portion is preferably, for example, about 5 μm or more and 200 μm or less in the middle of the first electrically conductive resin layer 60A provided on this portion in the length direction L and the width direction W.

In a case where the first electrically conductive resin layer 60A is also provided on a portion of the first lateral surface WS1 and a portion of the second lateral surface WS2, the thickness in the width direction W of the first electrically conductive resin layer 60A provided on this portion is preferably, for example, about 5 μm or more and 200 μm or less in the middle of the first electrically conductive resin layer 60A provided on this portion in the length direction L and the lamination direction T.

In a case where the second electrically conductive resin layer 60B is also provided on a portion of the first main surface TS1 and a portion of the second main surface TS2, the thickness in the lamination direction T of the second electrically conductive resin layer 60B provided on this portion is preferably, for example, about 5 μm or more and 200 μm or less in the middle of the second electrically conductive resin layer 60B provided on this portion in the length direction L and the width direction W.

In a case where the second electrically conductive resin layer 60B is also provided on a portion of the first lateral surface WS1 and a portion of the second lateral surface WS2, the thickness in the width direction W of the second electrically conductive resin layer 60B provided on this portion is preferably, for example, about 5 μm or more and 200 μm or less in the middle of the second electrically conductive resin layer 60B provided on this portion in the length direction L and the lamination direction T.

The electrically conductive resin layer 60 is provided on the base electrode layer 50. The plated layer 70 covers the electrically conductive resin layer 60 and a portion of the base electrode layer 50. The plated layer 70 includes a Ni plated layer 71 and a Sn plated layer 72.

The electrically conductive resin layer 60 includes a resin portion as a resin component, and an electrically conductive filler as a filler powder dispersed in the resin portion.

The resin portion of the electrically conductive resin layer 60 may include, for example, at least one selected from various known thermosetting resins such as epoxy resin, phenoxy resin, phenol resin, urethane resin, silicone resin, and polyimide resin. Among them, epoxy resins excelling in heat resistance, moisture resistance, adhesiveness and the like are one of the most suitable resins. The resin portion of the electrically conductive resin layer 60 preferably contains a curing agent together with the thermosetting resin. When an epoxy resin is used as the base resin, the curing agent of the epoxy resin may be any of various known compounds such as phenolic, amine-based, acid anhydride-based, imidazole-based, active ester-based, and amideimide-based compounds.

Since the electrically conductive resin layer 60 includes such a resin portion, it is more flexible than the base electrode layer 50 made of, for example, a plating film or a fired product of a metal component and a glass component. Therefore, even when a physical impact or shock caused by thermal cycling acts on the multilayer ceramic capacitor 1, the electrically conductive resin layer 60 functions as a buffer layer. Accordingly, it is possible for the electrically conductive resin layer 60 to reduce or prevent the generation of cracks in the multilayer ceramic capacitor 1.

The electrically conductive filler is dispersed in the resin portion in a substantially uniform distribution. The electrically conductive filler mainly maintains the conductivity of the electrically conductive resin layer 60. Specifically, when the plurality of electrically conductive fillers are brought into contact with each other, an electric current-carrying path is provided inside the electrically conductive resin layer 60, and the base electrode layer 50 and the plated layer 70 are electrically connected to each other.

The metal of the electrically conductive filler may be Ag alone, an alloy containing Ag, or a metal powder with Ag coated on the surface of the metal powder. Ag is suitable as electrode materials because of having the lowest specific resistance among metals. Since Ag is a noble metal, it hardly oxidizes and the weatherability is high. Therefore, the metal powder of Ag is suitable as the electrically conductive filler. When a metal powder coated with Ag is used, Cu, Ni, Sn, Bi or an alloy powder containing them is preferably used as the metal powder.

Further, the electrically conductive filler may be formed by subjecting Cu or Ni to an antioxidant treatment. The electrically conductive filler may be a metal powder obtained by coating the surface of the metal powder with Sn, Ni, or Cu. When a metal powder coated with Sn, Ni, or Cu is used, the metal powder is preferably Ag, Cu, Ni, Sn, or Bi or an alloy powder thereof. The electrically conductive filler more preferably includes Cu particles as a core. Further, it is more preferable that at least a portion of the surface of each of the Cu particles is coated with a Cu—Ag alloy of Cu and Ag. At least a portion of the surface of each of the Cu particles may be coated with Ag. With such a configuration, it is possible to improve the affinity with the Ni plating, and improve the electrical characteristics.

The shape of the electrically conductive filler is not particularly limited. The electrically conductive filler may have a spherical shape, a flat shape, or the like. Further, it is preferable to use a combination of metal powders having a spherical shape and a flat shape. In other words, the electrically conductive filler as the filler powder includes a flat powder or a spherical powder.

The average particle diameter of the electrically conductive filler may be, for example, 0.3 μm or more and 10 μm or less.

The average particle diameter of the electrically conductive filler contained in the electrically conductive resin layer 60 is calculated by using a laser diffraction particle size measurement method based on ISO 13320, regardless of the shape of the electrically conductive filler.

The plated layer 70 includes a first plated layer 70A and a second plated layer 70B.

The first plated layer 70A covers the first electrically conductive resin layer 60A and the first base electrode layer 50A. In the example embodiment, the first plated layer 70A extends from the first end surface LS1 to a portion of the first main surface TS1 and a portion of the second main surface TS2, and a portion of the first lateral surface WS1 and a portion of the second lateral surface WS2.

The second plated layer 70B covers the second electrically conductive resin layer 60B and the second base electrode layer 50B. In the example embodiment, the second plated layer 70B extends from the first end surface LS1 to a portion of the first main surface TS1 and a portion of the second main surface TS2, and a portion of the first lateral surface WS1 and a portion of the second lateral surface WS2.

The plated layer 70 preferably has a two-layer configuration of the Ni plated layer 71 and the Sn plated layer 72. The first Sn plated layer 72A is preferably provided on the first Ni plated layer 71A, and the second Sn plated layer 72B is preferably provided on the second Ni plated layer 71B. The Ni plated layer 71 prevents the base electrode layer 50 and the electrically conductive resin layer 60 from being eroded by solder when the multilayer ceramic capacitor 1 is mounted. The Sn plated layer 72 improves solder wettability when mounting the multilayer ceramic capacitor 1. This facilitates mounting of the multilayer ceramic capacitor 1.

The thicknesses of the first Ni plated layer 71A and the first Sn plated layer 72A are preferably 1 μm or more and 15 μm or less.

The thicknesses of the second Ni plated layer 71B and the second Sn plated layer 72B are preferably 1 μm or more and 15 μm or less.

The basic configuration of the multilayer ceramic capacitor 1 according to the example embodiment is described above. In addition, when the dimension in the length direction L of the multilayer ceramic capacitor 1 including the multilayer body 10 and the external electrodes 40 is defined as the L dimension, the L dimension is preferably 0.2 mm or more and 10 mm or less. When the dimension in the lamination direction T of the multilayer ceramic capacitor 1 is defined as the T dimension, the T dimension is preferably 0.05 mm or more and 10 mm or less. When the dimension in the width direction W of the multilayer ceramic capacitor 1 is defined as the W dimension, the W dimension is preferably 0.1 mm or more and 10 mm or less.

The multilayer ceramic capacitor 1 of the example embodiment including the above basic configuration encompasses the following features in the external electrodes 40, that is, the first external electrode 40A and the second external electrode 40B.

The external electrodes 40 of the example embodiment includes the main surface-side external electrode provided on at least one of the first main surface TS1 and the second main surface TS2. Specifically, as described above, the first external electrode 40A of the example embodiment is provided on the first end surface LS1, and extends from the first end surface LS1 to a portion of the first main surface TS1 and a portion of the second main surface TS2, and a portion of the first lateral surface WS1 and a portion of the second lateral surface WS2. That is, the first external electrode 40A of the example embodiment includes a first end surface-side external electrode 400A provided on the first end surface LS1, a first main surface-side external electrode 411A as a main surface-side external electrode provided on the first main surface TS1, a second main surface-side external electrode 412A as a main surface-side external electrode provided on the second main surface TS2 (shown in FIGS. 2 and 4), and a first lateral surface-side external electrode 421A provided on the first lateral surface WS1 and a second lateral surface-side external electrode 422A provided on the second lateral surface WS2 (shown in FIG. 4).

As described above, the first external electrode 40A includes the first base electrode layer 50A, the first electrically conductive resin layer 60A provided on the first base electrode layer 50A, and the first plated layer 70A provided on the first electrically conductive resin layer 60A. In the example embodiment, the first base electrode layer 50A extends from the first end surface LS1 to a portion of the first main surface TS1 and a portion of the second main surface TS2, a portion of the first lateral surface WS1, and a portion of the second lateral surface WS2, the first electrically conductive resin layer 60A covers the first base electrode layer 50A, and the first plated layer 70A covers the first electrically conductive resin layer 60A.

That is, as shown in FIGS. 2 and 4, the first end surface-side external electrode 400A of the example embodiment includes a first end surface-side base electrode layer 500A provided on the first end surface LS1, a first end surface-side electrically conductive resin layer 600A provided as an upper layer of the first end surface-side base electrode layer 500A, and a first end surface-side plated layer 700A provided as an upper layer of the first end surface-side electrically conductive resin layer 600A. The first end surface-side base electrode layer 500A is a portion of the first base electrode layer 50A. The first end surface-side electrically conductive resin layer 600A is a portion of the first electrically conductive resin layer 60A. The first end surface-side plated layer 700A is a portion of the first plated layer 70A, and includes a first Ni plated layer 71A and a first Sn plated layer 72A on the first Ni plated layer 71A.

As shown in FIG. 2, the first main surface-side external electrode 411A of the example embodiment includes a first main surface-side base electrode layer 511A provided on the first main surface TS1, a first main surface-side electrically conductive resin layer 611A provided as an upper layer of the first main surface-side base electrode layer 511A, and a first main surface-side plated layer 711A provided as an upper layer of the first main surface-side electrically conductive resin layer 611A. The first main surface-side base electrode layer 511A is a portion of the first base electrode layer 50A. The first main surface-side electrically conductive resin layer 611A is a portion of the first electrically conductive resin layer 60A. The first main surface-side plated layer 711A is a portion of the first plated layer 70A and includes a first Ni plated layer 71A and a first Sn plated layer 72A on the first Ni plated layer 71A.

As shown in FIG. 2, the second main surface-side external electrode 412A of the example embodiment includes a second main surface-side base electrode layer 512A provided on the second main surface TS2, a second main surface-side electrically conductive resin layer 612A provided as an upper layer of the second main surface-side base electrode layer 512A, and a second main surface-side plated layer 712A provided as an upper layer of the second main surface-side electrically conductive resin layer 612A. The second main surface-side base electrode layer 512A is a portion of the first base electrode layer 50A. The second main surface-side electrically conductive resin layer 612A is a portion of the first electrically conductive resin layer 60A. The second main surface-side plated layer 712A is a portion of the first plated layer 70A and includes a first Ni plated layer 71A and a first Sn plated layer 72A on the first Ni plated layer 71A.

As shown in FIG. 4, the first lateral surface-side external electrode 421A of the example embodiment includes a first lateral surface-side base electrode layer 521A provided on the first lateral surface WS1, a first lateral surface-side electrically conductive resin layer 621A provided as an upper layer of the first lateral surface-side base electrode layer 521A, and a first lateral surface-side plated layer 721A provided as an upper layer of the first lateral surface-side electrically conductive resin layer 621A. The first lateral surface-side base electrode layer 521A is a portion of the first base electrode layer 50A. The first lateral surface-side electrically conductive resin layer 621A is a portion of the first electrically conductive resin layer 60A. The first lateral surface-side plated layer 721A is a portion of the first plated layer 70A, and includes a first Ni plated layer 71A and a first Sn plated layer 72A on the first Ni plated layer 71A.

As shown in FIG. 4, the second lateral surface-side external electrode 422A of the example embodiment includes a second lateral surface-side base electrode layer 522A provided on the second lateral surface WS2, a second lateral surface-side electrically conductive resin layer 622A provided as an upper layer of the second lateral surface-side base electrode layer 522A, and a second lateral surface-side plated layer 722A provided as an upper layer of the second lateral surface-side electrically conductive resin layer 622A. The second lateral surface-side base electrode layer 522A is a portion of the first base electrode layer 50A. The second lateral surface-side electrically conductive resin layer 622A is a portion of the first electrically conductive resin layer 60A. The second lateral surface-side plated layer 722A is a portion of the first plated layer 70A, and includes a first Ni plated layer 71A and a first Sn plated layer 72A on the first Ni plated layer 71A.

The thicknesses of the first Ni plated layer 71A and the first Sn plated layer 72A of the first main surface-side base electrode layer 511A, the second main surface-side base electrode layer 512A, the first lateral surface-side base electrode layer 521A, and the second lateral surface-side base electrode layer 522A are preferably, for example, 5 μm or more and 10 μm or less, respectively.

The thicknesses of the first Ni plated layer 71A and the first Sn plated layer 72A of the first main surface-side plated layer 711A, the second main surface-side plated layer 712A, the first lateral surface-side plated layer 721A, and the second lateral surface-side plated layer 722A described above are preferably, for example, 1 μm or more and 4 μm or less.

As described above, the second external electrode 40B of the example embodiment is provided on the second end surface LS2, and extends from the second end surface LS2 to a portion of the first main surface TS1 and a portion of the second main surface TS2, and a portion of the first lateral surface WS1 and a portion of the second lateral surface WS2. That is, the second external electrode 40B of the example embodiment includes a second end surface-side external electrode 400B provided on the first end surface LS1, a first main surface-side external electrode 411B as a main surface-side external electrode provided on the first main surface TS1, and a second main surface-side external electrode 412B as a main surface-side external electrode provided on the second main surface TS2 (shown in FIG. 2), and a first lateral surface-side external electrode 421B provided on the first lateral surface WS1, and the second lateral surface-side external electrode 422B provided on the second lateral surface WS2 (shown in FIG. 4).

As described above, the second external electrode 40B includes the second base electrode layer 50B, the second electrically conductive resin layer 60B provided on the second base electrode layer 50B, and the second plated layer 70B provided on the second electrically conductive resin layer 60B. In the example embodiment, the second base electrode layer 50B extends from the second end surface LS2 to a portion of the first main surface TS1 and a portion of the second main surface TS2, a portion of the first lateral surface WS1, and a portion of the second lateral surface WS2, the second electrically conductive resin layer 60B covers the second base electrode layer 50B, and the second plated layer 70B covers the second electrically conductive resin layer 60B.

That is, as shown in FIGS. 2 and 4, the second end surface-side external electrode 400B of the example embodiment includes a second end surface-side base electrode layer 500B provided on the second end surface LS2, a second end surface-side electrically conductive resin layer 600B provided as an upper layer of the second end surface-side base electrode layer 500B, and a second end surface-side plated layer 700B provided as an upper layer of the second end surface-side electrically conductive resin layer 600B. The second end surface-side base electrode layer 500B is a portion of the second base electrode layer 50B. The second end surface-side electrically conductive resin layer 600B is a portion of the second electrically conductive resin layer 60B. The second end surface-side plated layer 700B is a portion of the second plated layer 70B, and includes a second Ni plated layer 71B and a second Sn plated layer 72B on the second Ni plated layer 71B.

As shown in FIG. 2, the first main surface-side external electrode 411B of the example embodiment includes a first main surface-side base electrode layer 511B provided on the first main surface TS1, a first main surface-side electrically conductive resin layer 611B provided as an upper layer of the first main surface-side base electrode layer 511B, and a first main surface-side plated layer 711B provided as an upper layer of the first main surface-side electrically conductive resin layer 611B. The first main surface-side base electrode layer 511B is a portion of the second base electrode layer 50B. The first main surface-side electrically conductive resin layer 611B is a portion of the second electrically conductive resin layer 60B. The first main surface-side plated layer 711B is a portion of the second plated layer 70B, and includes a second Ni plated layer 71B and a second Sn plated layer 72B on the second Ni plated layer 71B.

As shown in FIG. 2, the second main surface-side external electrode 412B of the example embodiment includes a second main surface-side base electrode layer 512B provided on the second main surface TS2, a second main surface-side electrically conductive resin layer 612B provided as an upper layer of the second main surface-side base electrode layer 512B, and a second main surface-side plated layer 712B provided as an upper layer of the second main surface-side electrically conductive resin layer 612B. The second main surface-side base electrode layer 512B is a portion of the second base electrode layer 50B. The second main surface-side electrically conductive resin layer 612B is a portion of the second electrically conductive resin layer 60B. The second main surface-side plated layer 712B is a portion of the second plated layer 70B, and includes a second Ni plated layer 71B and a second Sn plated layer 72B on the second Ni plated layer 71B.

As shown in FIG. 4, the first lateral surface-side external electrode 421B of the example embodiment includes a first lateral surface-side base electrode layer 521B provided on the first lateral surface WS1, a first lateral surface-side electrically conductive resin layer 621B provided as an upper layer of the first lateral surface-side base electrode layer 521B, and a first lateral surface-side plated layer 721B provided as an upper layer of the first lateral surface-side electrically conductive resin layer 621B. The first lateral surface-side base electrode layer 521B is a portion of the second base electrode layer 50B. The first lateral surface-side electrically conductive resin layer 621B is a portion of the second electrically conductive resin layer 60B. The first lateral surface-side plated layer 721B is a portion of the second plated layer 70B, and includes a second Ni plated layer 71B and a second Sn plated layer 72B on the second Ni plated layer 71B.

As shown in FIG. 4, the second lateral surface-side external electrode 422B of the example embodiment includes a second lateral surface-side base electrode layer 522B provided on the second lateral surface WS2, a second lateral surface-side electrically conductive resin layer 622B provided as an upper layer of the second lateral surface-side base electrode layer 522B, and a second lateral surface-side plated layer 722B provided as an upper layer of the second lateral surface-side electrically conductive resin layer 622B. The second lateral surface-side base electrode layer 522B is a portion of the second base electrode layer 50B. The second lateral surface-side electrically conductive resin layer 622B is a portion of the second electrically conductive resin layer 60B. The second lateral surface-side plated layer 722B is a portion of the second plated layer 70B, and includes a second Ni plated layer 71B and a second Sn plated layer 72B on the second Ni plated layer 71B.

The thicknesses of the second Ni plated layer 71B and the second Sn plated layer 72B provided as upper layers of the first main surface-side base electrode layer 511B, the second main surface-side base electrode layer 512B, the first lateral surface-side base electrode layer 521B, and the second lateral surface-side base electrode layer 522B are preferably, for example, 5 μm or more and 10 μm or less, respectively.

The thicknesses of the second Ni plated layer 71B and the second Sn plated layer 72B provided as upper layers of the first main surface-side plated layer 711B, the second main surface-side plated layer 712B, the first lateral surface-side plated layer 721B, and the second lateral surface-side plated layer 722B are preferably, for example, 1 μm or more and 4 μm or less.

Each of the main surface-side external electrodes 411A, 411B, 412A and 412B includes a main surface-side stepped portion 800 as a stepped portion. Each of the lateral surface-side external electrodes 421A, 421B, 422A and 422B includes a lateral surface-side stepped portion 900. Hereinafter, the main surface-side stepped portion 800 and the lateral surface-side stepped portion 900 will be described.

As shown in FIGS. 1B and 2, the first main surface-side external electrode 411A of the first external electrode 40A includes a first main surface-side stepped portion 810A as the main surface-side stepped portion 800. The first main surface-side stepped portion 810A is provided in the vicinity of substantially the middle of a surface 411sA of the first main surface-side external electrode 411A in the length direction L. The first main surface-side stepped portion 810A is a stepped portion that lowers the inner side in the length direction L (adjacent to the middle of the multilayer body 10 in the length direction L) of the surface 411sA of the first main surface-side external electrode 411A, and raises the outer side in the length direction L (adjacent to the end surface LS of the multilayer body 10 in the length direction L) of the surface 411sA of the first main surface-side external electrode 411A. That is, the height of the surface 411sA on the inner side in the length direction L with respect to the first main surface-side stepped portion 810A is lower than the height of the surface 411sA on the outer side in the length direction L with respect to the first main surface-side stepped portion 810A. Here, the height refers to a distance corresponding to the lamination direction T from the first main surface TS1 to the surface 411sA. In this manner, the surface 411sA of the first main surface-side external electrode 411A includes a height difference so that the inner side in the length direction L becomes lower and the outer side in the length direction L becomes higher due to the first main surface-side stepped portion 810A.

As shown in FIG. 1B, the first main surface-side stepped portion 810A has a curved shape that protrudes toward the inner side in the length direction L. The first main surface-side stepped portion 810A extends in the width direction W on the surface 411sA of the first main surface-side external electrode 411A. The first main surface-side stepped portion 810A of the example embodiment is symmetrical or substantially symmetrical in the width direction W with a line F1 extending along the length direction L in the middle in the width direction W of the first main surface-side external electrode 411A as a symmetric line, but may not necessarily be strictly symmetrical. The radius of curvature of the curved first main surface-side stepped portion 810A is not limited, but is preferably 150 μm or more and 800 μm or less, for example.

As shown in FIGS. 1B and 2, the first main surface-side external electrode 411A includes a first main surface-side edge 411eA as an edge functioning as a terminal end on the inner side in the length direction L at the end portion on the inner side in the length direction L. As shown in FIG. 1B, the first main surface-side edge 411eA has a curved shape that protrudes toward the inner side in the length direction. The first main surface-side edge 411eA of the example embodiment is symmetrical or substantially symmetrical in the width direction W with the line F1 as a symmetric line, but may not necessarily be strictly symmetrical. The curved shape of the first main surface-side edge 411eA has a curvature that is gentler and smaller than that of the first main surface-side stepped portion 810A and, therefore, is closer to a straight line than the first main surface-side stepped portion 810A. The radius of curvature of the curved first main surface-side edge 411eA is not limited, but is preferably 800 μm or more and 10 mm or less, for example.

The second main surface-side external electrode 412A also includes a main surface-side stepped portion similar to that of the first main surface-side external electrode 411A. As shown in FIG. 2, the second main surface-side external electrode 412A of the first external electrode 40A includes a second main surface-side stepped portion 820A as the main surface-side stepped portion 800. The second main surface-side stepped portion 820A is provided in the vicinity of substantially the middle of a surface 412sA of the second main surface-side external electrode 412A in the length direction L. The second main surface-side stepped portion 820A is a stepped portion that lowers the inner side in the length direction L of the surface 412sA of the second main surface-side external electrode 412A, and raises the outer side in the length direction L of the surface 412sA of the second main surface-side external electrode 412A. That is, the height of the surface 412sA on the inner side in the length direction L with respect to the second main surface-side stepped portion 820A is lower than the height of the surface 412sA on the outer side in the length direction L with respect to the second main surface-side stepped portion 820A. Here, the height refers to a distance corresponding to the lamination direction T from the second main surface TS2 to the surface 412sA. In this manner, the surface 412sA of the second main surface-side external electrode 412A has a height difference so that the inner side in the length direction L becomes lower and the outer side in the length direction L becomes higher due to the second main surface-side stepped portion 820A.

Although not shown, the second main surface-side stepped portion 820A also has a curved shape that protrudes toward the middle in the length direction L, similarly to the first main surface-side stepped portion 810A. The second main surface-side stepped portion 820A extends in the width direction W on the surface 412sA of the second main surface-side external electrode 412A. The second main surface-side stepped portion 820A of the example embodiment is also symmetrical or substantially symmetrical in the width direction W, but may not necessarily be strictly symmetrical. The radius of curvature of the curved second main surface-side stepped portion 820A is not limited, but is preferably 150 μm or more and 800 μm or less, for example.

As shown in FIG. 2, the second main surface-side external electrode 412A includes a second main surface-side edge 412eA as an edge functioning as a terminal end on the inner side in the length direction L at the end portion on the inner side in the length direction L. Similarly to the first main surface-side edge 411eA, the second main surface-side edge 412eA also has a curved shape that protrudes toward the inner side in the length direction. The second main surface-side edge 412eA of the example embodiment is also symmetrical or substantially symmetrical in the width direction W, but may not necessarily be strictly symmetrical. The curved shape of the second main surface-side edge 412eA has a curvature gentler and smaller than that of the second main surface-side stepped portion 820A and, therefore, is closer to a straight line than the second main surface-side stepped portion 820A. The radius of curvature of the curved second main surface-side edge 412eA is not limited, but is preferably 800 μm or more and 10 mm or less, for example.

As shown in FIGS. 1B and 2, the first main surface-side external electrode 411B of the second external electrode 40B includes a first main surface-side stepped portion 810B as the main surface-side stepped portion 800. The first main surface-side stepped portion 810B is provided in the vicinity of substantially the middle of the surface 411sB of the first main surface-side external electrode 411B in the length direction L. The first main surface-side stepped portion 810B is a stepped portion that lowers the inner side in the length direction L and raises the outer side in the length direction L of the surface 411sB of the first main surface-side external electrode 411B. That is, the height of the surface 411sB on the inner side in the length direction L with respect to the first main surface-side stepped portion 810B is lower than the height of the surface 411sB on the outer side in the length direction L with respect to the first main surface-side stepped portion 810B. Here, the height refers to a distance corresponding to the lamination direction T from the first main surface TS1 to the surface 411sB. In this manner, the surface 411sB of the first main surface-side external electrode 411B includes a height difference so that the inner side in the length direction L becomes lower and the outer side in the length direction L becomes higher due to the first main surface-side stepped portion 810B.

As shown in FIG. 1B, the first main surface-side stepped portion 810B has a curved shape that protrudes toward the inner side in the length direction L. The first main surface-side stepped portion 810B extends in the width direction W on the surface 411sB of the first main surface-side external electrode 411B. The first main surface-side stepped portion 810B of the example embodiment is symmetrical or substantially symmetrical in the width direction W, with a line F2 extending along the length direction L in the middle in the width direction W of the first main surface-side external electrode 411B as a symmetric line, but may not necessarily be strictly symmetrical. The radius of curvature of the curved first main surface-side stepped portion 810B is not limited, but is preferably, for example, 150 μm or more and 800 μm or less.

As shown in FIGS. 1B and 2, the first main surface-side external electrode 411B includes a first main surface-side edge 411eB as an edge functioning as a terminal end on the inner side in the length direction L at the end portion on the inner side in the length direction L. As shown in FIG. 1B, the first main surface-side edge 411eB has a curved shape that protrudes toward the inner side in the length direction. The first main surface-side edge 411eB of the example embodiment is symmetrical or substantially symmetrical in the width direction W with the line F2 as a symmetric line, but may not necessarily be strictly symmetrical. The curved shape of the first main surface-side edge 411eB has a curvature gentler and smaller than that of the first main surface-side stepped portion 810B and, therefore, is closer to a straight line than the first main surface-side stepped portion 810B. The radius of curvature of the curved first main surface-side edge 411eB is not limited, but is preferably 800 μm or more and 10 mm or less, for example.

The second main surface-side external electrode 412B also includes a main surface-side stepped portion similar to that of the first main surface-side external electrode 411B. As shown in FIG. 2, the second main surface-side external electrode 412B of the second external electrode 40B includes a second main surface-side stepped portion 820B as the main surface-side stepped portion 800. The second main surface-side stepped portion 820B is provided in the vicinity of substantially the middle of a surface 412sB of the second main surface-side external electrode 412B in the length direction L. The second main surface-side stepped portion 820B is a stepped portion that lowers the inner side in the length direction L and raises the outer side in the length direction L of the surface 412sB of the second main surface-side external electrode 412B. That is, the height of the surface 412sB on the inner side in the length direction L with respect to the second main surface-side stepped portion 820B is lower than the height of the surface 412sB on the outer side in the length direction L with respect to the second main surface-side stepped portion 820B. Here, the height refers to a distance corresponding to the lamination direction T from the second main surface TS2 to the surface 412sB. In this manner, the surface 412sB of the second main surface-side external electrode 412B has a height difference so that the inner side in the length direction L becomes lower and the outer side in the length direction L becomes higher due to the second main surface-side stepped portion 820B.

Although not shown, the second main surface-side stepped portion 820B also has a curved shape that protrudes toward the middle in the length direction L, similarly to the first main surface-side stepped portion 810B. The second main surface-side stepped portion 820B extends in the width direction W on the surface 412sB of the second main surface-side external electrode 412B. The second main surface-side stepped portion 820B of the example embodiment is also symmetrical or substantially symmetrical in the width direction W, but may not necessarily be strictly symmetrical. The radius of curvature of the curved second main surface-side stepped portion 820B is not limited, but is preferably 150 μm or more and 800 μm or less, for example.

As shown in FIG. 2, the second main surface-side external electrode 412B includes a second main surface-side edge 412eB as an edge functioning as a terminal end on the inner side in the length direction L at the end portion on the inner side in the length direction L. Similarly to the first main surface-side edge 411eB, the second main surface-side edge 412eB also has a curved shape that protrudes toward the inner side in the length direction. The second main surface-side edge 412eB of the example embodiment is also symmetrical or substantially symmetrical in the width direction W, but may not necessarily be strictly symmetrical. The curved shape of the second main surface-side edge 412eB has a curvature gentler and smaller than that of the second main surface-side stepped portion 820B and, therefore, is closer to a straight line than the second main surface-side stepped portion 820B. The radius of curvature of the curved second main surface-side edge 412eB is not limited, but is preferably 800 μm or more and 10 mm or less, for example.

As shown in FIG. 1C and FIG. 4, the second lateral surface-side external electrode 422A of the first external electrode 40A includes surface-side stepped portion 920A as the lateral surface-side stepped portion 900. The second lateral surface-side stepped portion 920A includes the same or substantially same configuration as each of the main surface-side stepped portions 810A, 820A, 810B and 820B. The second lateral surface-side stepped portion 920A is provided in the vicinity of substantially the middle of the surface 422sA of the second lateral surface-side external electrode 422A in the length direction L. The second lateral surface-side stepped portion 920A is a stepped portion that lowers the inner side in the length direction L and raises the outer side in the length direction L of the surface 422sA of the second lateral surface-side external electrode 422A. That is, the height of the surface 422sA on the inner side in the length direction L with respect to the second lateral surface-side stepped portion 920A is lower than the height of the surface 422sA on the outer side in the length direction L with respect to the second lateral surface-side stepped portion 920A. Here, the height refers to a distance corresponding to the width direction W from the second lateral surface WS2 to the surface 422sA. In this manner, the surface 422sA of the second lateral surface-side external electrode 422A includes a height difference so that the inner side in the length direction L becomes lower and the outer side in the length direction L becomes higher due to the second lateral surface-side stepped portion 920A.

As shown in FIG. 1C, the second lateral surface-side stepped portion 920A has a curved shape that protrudes toward the inner side in the length direction L. The second lateral surface-side stepped portion 920A extends in the lamination direction T on the surface 422sA of the second lateral surface-side external electrode 422A. The second lateral surface-side stepped portion 920A of the example embodiment is symmetrical or substantially symmetrical in the lamination direction T with a line F3 extending along the length direction L in the middle of the second lateral surface-side external electrode 422A in the lamination direction T as a symmetric line, but may not necessarily be strictly symmetrical. The radius of curvature of the curved second lateral surface-side stepped portion 920A is not limited, but is preferably, for example, 150 μm or more and 800 μm or less.

As shown in FIGS. 1C and 4, the second lateral surface-side external electrode 422A includes a second lateral surface-side edge 422eA as an edge functioning as a terminal end on the inner side in the length direction L at the end portion on the inner side in the length direction L. As shown in FIG. 1C, the second lateral surface-side edge 422eA has a curved shape that protrudes toward the inner side in the length direction. The second lateral surface-side edge 422eA of the example embodiment is symmetrical or substantially symmetrical in the lamination direction T with the line F3 as a symmetric line, but may not necessarily be strictly symmetrical. The curved shape of the second lateral surface-side edge 422eA has a curvature gentler and smaller than that of the second lateral surface-side stepped portion 920A and, therefore, is closer to a straight line than the second lateral surface-side stepped portion 920A. The radius of curvature of the curved second lateral surface-side edge 422eA is not limited, but is preferably 800 μm or more and 10 mm or less, for example.

The second lateral surface-side stepped portion 920A may be continuous with one or both of the first main surface-side stepped portion 810A and the second main surface-side stepped portion 820A described above, or may not be continuous with either of them.

The first lateral surface-side external electrode 421A also includes a lateral surface-side stepped portion similar to that of the second lateral surface-side external electrode 422A. As shown in FIG. 4, the first lateral surface-side external electrode 421A of the first external electrode 40A includes a first lateral surface-side stepped portion 910A as the lateral surface-side stepped portion 900. The first lateral surface-side stepped portion 910A is provided in the vicinity of substantially the middle of the surface 421sA of the first lateral surface-side external electrode 421A in the length direction L. The first lateral surface-side stepped portion 910A is a stepped portion that lowers the inner side in the length direction L and raises the outer side in the length direction L of the surface 421sA of the first lateral surface-side external electrode 421A. That is, the height of the surface 421sA on the inner side in the length direction L with respect to the first lateral surface-side stepped portion 910A is lower than the height of the surface 421sA on the outer side in the length direction L with respect to the first lateral surface-side stepped portion 910A. Here, the height refers to a distance corresponding to the width direction W from the first lateral surface WS1 to the surface 421sA. In this manner, the surface 421sA of the first lateral surface-side external electrode 421A has a height difference so that the inner side in the length direction L becomes lower and the outer side in the length direction L becomes higher due to the first lateral surface-side stepped portion 910A.

Although not shown, the first lateral surface-side stepped portion 910A also has a curved shape that protrudes toward the middle in the length direction L, similarly to the second lateral surface-side stepped portion 920A. The first lateral surface-side stepped portion 910A extends in the width direction W on the surface 421sA of the first lateral surface-side external electrode 421A. The first lateral surface-side stepped portion 910A of the example embodiment is also symmetrical or substantially symmetrical in the lamination direction T, but may not necessarily be strictly symmetrical. The radius of curvature of the curved first lateral surface-side stepped portion 910A is not limited, but is preferably 150 μm or more and 800 μm or less, for example.

As shown in FIG. 4, the first lateral surface-side external electrode 421A includes a first lateral surface-side edge 421eA as an edge functioning as a terminal end on the inner side in the length direction L at the end portion on the inner side in the length direction L. Similarly to the second lateral surface-side edge 422eA, the first lateral surface-side edge 421eA also has a curved shape that protrudes toward the inner side in the length direction. The first lateral surface-side edge 421eA of the example embodiment is also symmetrical or substantially symmetrical in the lamination direction T, but may not necessarily be strictly symmetrical. The curved shape of the first lateral surface-side edge 421eA has a curvature gentler and smaller than that of the first lateral surface-side stepped portion 910A and, therefore, is closer to a straight line than the first lateral surface-side stepped portion 910A. The radius of curvature of the curved first lateral surface-side edge 421eA is not limited, but is preferably 800 μm or more and 10 mm or less, for example.

The first lateral surface-side stepped portion 910A may be continuous with one or both of the first main surface-side stepped portion 810A and the second main surface-side stepped portion 820A described above, or may not be continuous with either of them.

As shown in FIG. 1C and FIG. 4, the second lateral surface-side external electrode 422B of the second external electrode 40B includes a second lateral surface-side stepped portion 920B as the lateral surface-side stepped portion 900. The second lateral surface-side stepped portion 920B is provided in the vicinity of substantially the middle of the surface 422sB of the second lateral surface-side external electrode 422B in the length direction L. The second lateral surface-side stepped portion 920B is a stepped portion that lowers the inner side in the length direction L and raises the outer side in the length direction L of the surface 422sB of the second lateral surface-side external electrode 422B. That is, the height of the surface 422sB on the inner side in the length direction L with respect to the second lateral surface-side stepped portion 920B is lower than the height of the surface 422sB on the outer side in the length direction L with respect to the second lateral surface-side stepped portion 920B. Here, the height refers to a distance corresponding to the width direction W from the second lateral surface WS2 to the surface 422sB. In this manner, the surface 422sB of the second lateral surface-side external electrode 422B includes a height difference so that the inner side in the length direction L becomes lower and the outer side in the length direction L becomes higher due to the second lateral surface-side stepped portion 920B.

As shown in FIG. 1C, the second lateral surface-side stepped portion 920B has a curved shape that protrudes toward the inner side in the length direction L. The second lateral surface-side stepped portion 920B extends in the width direction W on the surface 422sB of the second lateral surface-side external electrode 422B. The second lateral surface-side stepped portion 920B of the example embodiment is symmetrical or substantially symmetrical in the lamination direction T with a line F4 extending along the length direction L in the middle in the width direction W of the second lateral surface-side external electrode 422B as a symmetric line, but may not necessarily be strictly symmetrical. The radius of curvature of the curved second lateral surface-side stepped portion 920B is not limited, but is preferably 150 μm or more and 800 μm or less, for example.

As shown in FIGS. 1C and 4, the second lateral surface-side external electrode 422B includes a second lateral surface-side edge 422eB as an edge functioning as a terminal end on the inner side in the length direction L at the end portion on the inner side in the length direction L. As shown in FIG. 1C, the second lateral surface-side edge 422eB has a curved shape that protrudes toward the inner side in the length direction. The second lateral surface-side edge 422eB of the example embodiment is symmetrical or substantially symmetrical in the lamination direction T with the line F4 as a symmetric line, but may not necessarily be strictly symmetrical. The curved shape of the second lateral surface-side edge 422eB has a curvature gentler and smaller than that of the second lateral surface-side stepped portion 920B and, therefore, is closer to a straight line than the second lateral surface-side stepped portion 920B. The radius of curvature of the curved second lateral surface-side edge 422eB is not limited, but is preferably 800 μm or more and 10 mm or less, for example.

The second lateral surface-side stepped portion 920B may be continuous with one or both of the first main surface-side stepped portion 810B and the second main surface-side stepped portion 820B described above, or may not be continuous with either of them.

The first lateral surface-side external electrode 421B also includes a lateral surface-side stepped portion similar to that of the second lateral surface-side external electrode 422B. As shown in FIG. 4, the first lateral surface-side external electrode 421B of the second external electrode 40B includes a first lateral surface-side stepped portion 910B as the lateral surface-side stepped portion 900. The first lateral surface-side stepped portion 910B is provided in the vicinity of substantially the middle of the surface 421sB of the first lateral surface-side external electrode 421B in the length direction L. The first lateral surface-side stepped portion 910B is a stepped portion that lowers the inner side in the length direction L and raises the outer side in the length direction L of the surface 421sB of the first lateral surface-side external electrode 421B. That is, the height of the surface 421sB on the inner side in the length direction L with respect to the first lateral surface-side stepped portion 910B is lower than the height of the surface 421sB on the outer side in the length direction L with respect to the first lateral surface-side stepped portion 910B. Here, the height refers to a distance corresponding to the width direction W from the first lateral surface WS1 to the surface 421sB. In this manner, the surface 421sB of the first lateral surface-side external electrode 421B has a height difference so that the inner side in the length direction L becomes lower and the outer side in the length direction L becomes higher due to the first lateral surface-side stepped portion 910B.

Although not shown, the first lateral surface-side stepped portion 910B also has a curved shape that protrudes toward the middle in the length direction L, similarly to the second lateral surface-side stepped portion 920B. The first lateral surface-side stepped portion 910B extends in the lamination direction T on the surface 421sB of the first lateral surface-side external electrode. The first lateral surface-side stepped portion 910B of the example embodiment is also symmetrical or substantially symmetrical in the lamination direction, but may not necessarily be strictly symmetrical. The radius of curvature of the curved first lateral surface-side stepped portion 910B is not limited, but is preferably 150 μm or more and 800 μm or less, for example.

As shown in FIG. 4, the first lateral surface-side stepped portion 910B includes a first lateral surface-side edge 421eB as an edge functioning as a terminal end on the inner side in the length direction L at the end portion on the inner side in the length direction L. The first lateral surface-side edge 421eB also has a curved shape that protrudes toward the inner side in the length direction, similarly to the second lateral surface-side edge 422eB. The first lateral surface-side edge 421eB of the example embodiment is symmetrical also or substantially symmetrical in the lamination direction T, but may not necessarily be strictly symmetrical. The curved shape of the first lateral surface-side edge 421eB has a curvature gentler and smaller than that of the first lateral surface-side stepped portion 910B and, therefore, is closer to a straight line than the first lateral surface-side stepped portion 910B. The radius of curvature of the curved first lateral surface-side edge 421eB is not limited, but is preferably 800 μm or more and 10 mm or less, for example.

The first lateral surface-side stepped portion 910B may be continuous with one or both of the first main surface-side stepped portion 810B and the second main surface-side stepped portion 820B described above, or may not be continuous with either of them.

Each main surface-side stepped portion 800 and each lateral surface-side stepped portion 900 described above will be described in more detail. Here, the first main surface-side external electrode 411A and the second main surface-side external electrode 412A of the first external electrode 40A, and the first main surface-side external electrode 411B and the second main surface-side external electrode 412B of the second external electrode 40B have the same or substantially same configuration. Further, the first lateral surface-side external electrode 421A and the second lateral surface-side external electrode 422A of the first external electrode 40A, and the first lateral surface-side external electrode 421B and the second lateral surface-side external electrode 422B of the second external electrode 40B also have the same or substantially same configuration as the four main surface-side external electrodes 411A, 412A, 411B and 412B.

Each main surface-side stepped portion 800 of the first external electrode 40A, that is, the first main surface-side stepped portion 810A and the second main surface-side stepped portion 820A, and the first main surface-side stepped portion 810B and the second main surface-side stepped portion 820B of the second external electrode 40B, have the same or substantially same configuration. In addition, each lateral surface-side stepped portion 900 of the first external electrode 40A, that is, the first lateral surface-side stepped portion 910A and the second lateral surface-side stepped portion 920A, and the first lateral surface-side stepped portion 910B and the second lateral surface-side stepped portion 920B of the second external electrode 40B also, have the same or substantially same configuration as the four main surface-side stepped portions 810A, 820A, 810B and 820B.

Therefore, the first main surface-side external electrode 411A and the first main surface-side stepped portion 810A of the first external electrode 40A will be described below as examples of the four main surface-side external electrodes and the main surface-side stepped portions 800 and the four lateral surface-side external electrodes and the four lateral surface-side stepped portions 900. These descriptions also serve as the descriptions for the four main surface-side external electrodes and the four main surface-side stepped portions 800 and the four lateral surface-side external electrodes and the four lateral surface-side stepped portions 900.

The first main surface-side external electrode 411A of the first external electrode 40A corresponds to the second main surface-side external electrode 412A, the first lateral surface-side external electrode 421A, and the second lateral surface-side external electrode 422A of the first external electrode 40A, and the first main surface-side external electrode 411B, the second main surface-side external electrode 412B, the first lateral surface-side external electrode 421B, and the second lateral surface-side external electrode 422B of the second external electrode 40B. The first main surface-side stepped portion 810A of the first external electrode 40A corresponds to the second main surface-side stepped portion 820A, the first lateral surface-side stepped portion 910A, and the second lateral surface-side stepped portion 920A of the first external electrode 40A, and the first main surface-side stepped portion 810B, the second main surface-side stepped portion 820B, the first lateral surface-side stepped portion 910B, and the second lateral surface-side stepped portion 920B of the second external electrode 40B.

The first base electrode layer 50A, the first electrically conductive resin layer 60A, and the first plated layer 70A included in the first external electrode 40A correspond to the second base electrode layer 50B, the second electrically conductive resin layer 60B, and the second plated layer 70B included in the second external electrode 40B. The first Ni plated layer 71A and the first Sn plated layer 72A included in the first plated layer 70A of the first external electrode 40A correspond to the second Ni plated layer 71B and the second Sn plated layer 72B included in the second plated layer 70B of the second external electrode 40B.

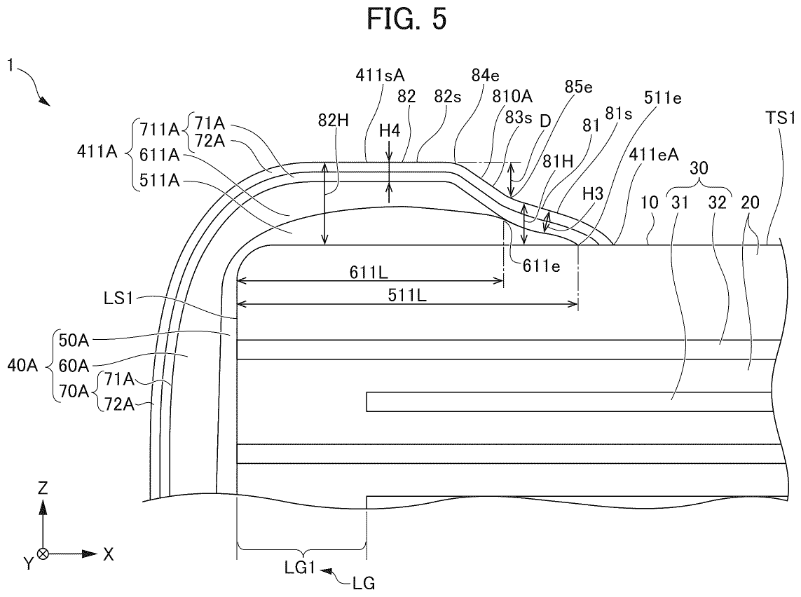

FIG. 5 is an enlarged view of a portion indicated by V in FIG. 2, and is an LT cross-sectional view showing the first main surface-side external electrode 411A of the first external electrode 40A. FIG. 5 shows an XYZ orthogonal coordinate system similar to FIGS. 1A to 4. In FIG. 5, hatching is omitted in order to clearly show the reference numerals, the drawing lines for the reference numerals, and the dimension lines.

As shown in FIG. 5, the first main surface-side external electrode 411A of the first external electrode 40A includes the first main surface-side base electrode layer 511A provided on the first main surface TS1 and the first main surface-side electrically conductive resin layer 611A, and the first main surface-side plated layer 711A including the first Ni plated layer 71A and the first Sn plated layer 72A.

As described above, the surface 411sA of the first main surface-side external electrode 411A has a height difference so that the inner side in the length direction L becomes lower and the outer side in the length direction L becomes higher due to the first main surface-side stepped portion 810A. That is, the first main surface-side external electrode 411A includes the first main surface-side stepped portion 810A, an inner thin portion 81 located on the inner side in the length direction L (adjacent to the middle of the multilayer body 10 in the length direction L) of the first main surface-side stepped portion 810A, and an outer thick portion 82 located on the outer side in the length direction L of the first main surface-side stepped portion 810A. The surface 411sA of the first main surface-side external electrode 411A includes a surface 81s of the inner thin portion 81, a surface 82s of the outer thick portion 82, and a surface 83s of the first main surface-side stepped portion 810A.

The outer thick portion 82 and the first main surface-side stepped portion 810A include the first main surface-side base electrode layer 511A, the first main surface-side electrically conductive resin layer 611A, and the first main surface-side plated layer 711A. The inner thin portion 81 includes the first main surface-side base electrode layer 511A and the first main surface-side plated layer 711A. Specifically, the outer thick portion 82 and the first main surface-side stepped portion 810A include the first main surface-side base electrode layer 511A, the first main surface-side electrically conductive resin layer 611A provided on the first main surface-side base electrode layer 511A, and the first main surface-side plated layer 711A provided on the first main surface-side electrically conductive resin layer 611A. The inner thin portion 81 includes the first main surface-side base electrode layer 511A and the first main surface-side plated layer 711A provided directly on the first main surface-side base electrode layer 511A. Therefore, in the inner thin portion 81 located on the inner side in the length direction L of the first main surface-side stepped portion 810A, the first main surface-side plated layer 711A is provided, and the first main surface-side electrically conductive resin layer 611A is not provided, on the first main surface-side base electrode layer 511A.

A distance in the lamination direction T from the first main surface TS1 of the multilayer body 10 to the surface 81s of the inner thin portion 81 is a height (thickness) 81H of the inner thin portion 81. A distance in the lamination direction T from the first main surface TS1 to the surface 82s of the outer thick portion 82 is a height (thickness) 82H of the outer thick portion 82. The maximum height 81H of the inner thin portion 81 is lower than the maximum height 82H of the outer thick portion 82.

A surface 83s of the first main surface-side stepped portion 810A is a surface that connects the surface 82s of the outer thick portion 82 and the surface 81s of the inner thin portion 81, and is sloped so as to approach the first main surface TS1 from the outer side toward the inner side in the length direction L. The thickness of the stepped portion of the first main surface-side stepped portion 810A, that is, the stepped amount D provided between the outer end 84e and the inner end 85e in the length direction L of the first main surface-side stepped portion 810A, is not limited, but is preferably, for example, 3 μm or more and 40 μm or less. The stepped amount D is preferably 5% or more and 60% or less of the maximum thickness of the first main surface-side external electrode 411A, that is, the maximum thickness of the outer thick portion 82. The stepped amount D is preferably larger than the thickness of the first Ni plated layer 71A.

As above, described the first main surface-side electrically conductive resin layer 611A is not provided at the inner thin portion 81, and the inner end 611e of the first main surface-side electrically conductive resin layer 611A is located at the same or substantially same position as the inner end 85e of the first main surface-side stepped portion 810A in the length direction L or is located on the outer side of the inner end 85e of the first main surface-side stepped portion 810A (adjacent to the first end surface LS1). The inner end 511e of the first main surface-side base electrode layer 511A is located on the inner side in the length direction L (adjacent to the middle of the multilayer body 10) of the inner end 85e of the first main surface-side stepped portion 810A. Therefore, a length 511L in the length direction L from the first end surface LS1 to the inner end 511e of the first main surface-side base electrode layer 511A is longer than a length 611L in the length direction L from the first end surface LS1 to the inner end 611e of the first main surface-side electrically conductive resin layer 611A.

In the example embodiment, the thickness H3 of the first main surface-side plated layer 711A of the thin portion 81 is preferably larger than the thickness H4 of the first main surface-side plated layer 711A of the outer thick portion 82.

The multilayer ceramic capacitor 1 of the example embodiment is mounted on a substrate. In mounting on a substrate, the external electrode 40 may be bonded to a terminal or the like of the substrate by soldering. When the first main surface-side external electrode 411A is bonded to the substrate by soldering, a deflection stress generated in the first main surface-side external electrode 411A is transmitted to the multilayer body 10, and thus a crack or the like may occur in the multilayer body 10. Here, in the multilayer ceramic capacitor 1 of the example embodiment, since the first main surface-side external electrode 411A includes the first main surface-side stepped portion 810A that is curved and protrudes toward the inner side (adjacent to the middle) in the length direction L of the multilayer body 10, the above-described deflection stress is easily held uniformly at the interface between the first main surface-side external electrode 411A and the multilayer body 10, and is dispersed in the first main surface-side stepped portion 810A or in the periphery of the first main surface-side stepped portion 810A. With such a configuration, it is possible to improve the deflection resistance, and it is possible to reduce or prevent the occurrence of cracks in the multilayer body 10. The same applies to the other main surface-side external electrodes and the other lateral surface-side external electrodes.

In the multilayer ceramic capacitor 1 of the example embodiment, as described above, when the first main surface-side external electrode 411A is viewed, the curved shape of the first main surface-side edge 411eA has a curvature that is gentler and smaller than that of the first main surface-side stepped portion 810A and, therefore, is closer to a straight line than the first main surface-side stepped portion 810A. With such a configuration, the above-described deflection stress generated at the time of substrate mounting is easily held uniformly at the interface between the first main surface-side external electrode 411A and the multilayer body 10, and is dispersed in the first main surface-side stepped portion 810A or in the periphery of the first main surface-side stepped portion 810A. With such a configuration, it is possible to improve the deflection resistance, and it is possible to reduce or prevent the occurrence of cracks in the multilayer body 10. The same applies to the other main surface-side external electrodes and the other lateral surface-side external electrodes.

In the multilayer ceramic capacitor 1 of the example embodiment, as described above, when the first main surface-side external electrode 411A is viewed, the first main surface-side electrically conductive resin layer 611A is not provided at the inner thin portion 81 on the inner side in the length direction L of the first main surface-side stepped portion 810A, and the inner end 611e of the first main surface-side electrically conductive resin layer 611A is located at the same or substantially same position as the inner end 85e of the first main surface-side stepped portion 810A in the length direction L or located on the outer side of the inner end 85e of the first main surface-side stepped portion 810A. With such a configuration, it is possible to reduce the amount of the first main surface-side electrically conductive resin layer 611A, and accordingly, it is possible to reduce or prevent a dimensional increase of the first external electrode 40A. In addition, in the inner thin portion 81, since a region in which the first main surface-side base electrode layer 511A and the first main surface-side plated layer 711A are directly connected to each other is provided without the first main surface-side electrically conductive resin layer 611A interposed therebetween, it is possible to reduce the electrical resistance, even in a configuration including the electrically conductive resin layer. The same applies to the other main surface-side external electrodes and the other lateral surface-side external electrodes.

In the multilayer ceramic capacitor 1 of the example embodiment, as described above, when the first main surface-side external electrode 411A is viewed, the thickness H3 of the first main surface-side plated layer 711A of the thin portion 81 is preferably larger than the thickness H4 of the first main surface-side plated layer 711A of the outer thick portion 82. In this case, it is possible to increase the compressive stress due to plating, and it is possible to improve the deflection resistance. The cracking due to the deflection of the multilayer body 10 occurs when stress is applied to the side where the multilayer body 10 is pulled in the length direction L. In a case where the plated layer has a compressive stress as a residual stress, since the compressive stress due to plating is a stress acting in a direction opposite to the direction of the stress applied to the side where the multilayer body 10 is pulled in the length direction L, the compressive stress due to plating is increased, and thus the deflection resistance is improved. In addition, since a portion including a large plating thickness is provided, the mountability of the substrate is improved. The same applies to the other main surface-side external electrodes and the other lateral surface-side external electrodes. On the other hand, since the thickness H4 directly affects the external dimensions of the multilayer ceramic capacitor 1, it is preferable that the thickness H4 is relatively small.

Each dimension such as the thickness of each layer constituting the first main surface-side external electrode 411A and the stepped amount D of the first main surface-side stepped portion 810A is measured by, for example, the following method. That is, the multilayer ceramic capacitor 1 is polished from the first lateral surface WS1 or the second lateral surface WS2 to a position of approximately one half of the dimension in the width direction W. As a result, the LT cross section at the middle position in the width direction W of the multilayer ceramic capacitor 1 is exposed. Next, the dimensions in the LT cross section exposed by polishing are measured using a digital microscope.

Next, a method of manufacturing the multilayer ceramic capacitor 1 of the present example embodiment will be described. The method of manufacturing the multilayer ceramic capacitor 1 of the present example embodiment is not limited as long as it satisfies the above-mentioned requirements. However, a preferred manufacturing method includes the following processes. The details of each process will be described below.

A dielectric sheet for forming the dielectric layer 20 and an electrically conductive paste for forming the internal electrode layer 30 are prepared. The dielectric sheet and the electrically conductive paste for forming the internal electrodes include a binder and a solvent. The binder and the solvent may be well known.

The electrically conductive paste for forming the internal electrode layer 30 is printed on the dielectric sheet in a predetermined pattern by, for example, screen printing or gravure printing. Thus, a dielectric sheet having a pattern of the first internal electrode layer 31 and a dielectric sheet having a pattern of the second internal electrode layer 32 are prepared.

By laminating a predetermined number of dielectric sheets on which patterns of internal electrode layers are not printed, a portion functioning as the first main surface-side outer layer portion 12A adjacent to the first main surface TS1 is formed. A dielectric sheet on which the pattern of the first internal electrode layer 31 is printed and a dielectric sheet on which the pattern of the second internal electrode layer 32 is printed are sequentially laminated thereon, such that a portion functioning as the inner layer portion 11 is formed. A predetermined number of dielectric sheets on which patterns of internal electrode layers are not printed are laminated on a portion functioning as the inner layer portion 11, such that a portion functioning as the second main surface-side outer layer portion 12B adjacent to the second main surface TS2 is formed. Thus, a multilayer sheet is manufactured.

The multilayer sheet is pressed in the lamination direction by means of a hydrostatic press or the like to form a multilayer block.

By cutting the multilayer block into a predetermined size, the multilayer chip is cut out. At this time, the corner portions and ridge portions of the multilayer chip may be rounded by barrel polishing or the like.

The multilayer chip is fired to form the multilayer body 10. The firing temperature depends on the materials of the dielectric layer 20 and the internal electrode layer 30, but is preferably 900° C. or higher and 1400° C. or lower.

An electrically conductive paste functioning as the base electrode layer 50 is applied to both end surfaces of the multilayer body 10. In the present example embodiment, the base electrode layer 50 is a fired layer. An electrically conductive paste containing a glass component and a metal is applied to the multilayer body 10 by a method such as dipping. Then, firing treatment is performed to form the base electrode layer 50. The temperature of the firing treatment at this time is preferably 700° C. or higher and 950° C. or lower.

In the example embodiment, dipping is performed so that the first base electrode layer 50A extends from the first end surface LS1 to a portion of the first main surface TS1 and a portion of the second main surface TS2. The dipping is also performed so that the second base electrode layer 50B extends from the second end surface LS2 to a portion of the first main surface TS1 and a portion of the second main surface TS2. At the same time, the dipping is preferably performed so that the first base electrode layer 50A extends to a portion of the first lateral surface WS1 and a portion of the second lateral surface WS2. The dipping is also preferably performed so that the second base electrode layer 50B extends to a portion of the first lateral surface WS1 and a portion of the second lateral surface WS2.

The multilayer chip before firing and the electrically conductive paste applied to the multilayer chip may be fired simultaneously. In this case, the fired layer is preferably formed by firing a ceramic material added instead of the glass component. At this time, it is particularly preferable to use the same kind of ceramic material as the dielectric layer 20 as the ceramic material to be added. In this case, the electrically conductive paste is applied to the multilayer chip before firing, and the multilayer chip and the electrically conductive paste applied to the multilayer chip are fired at the same time to form the multilayer body 10 in which the fired layer is formed.

Next, the electrically conductive resin layer 60 is formed. In the example embodiment, the electrically conductive resin layer 60 is formed on the surface of the base electrode layer 50.

First, an electrically conductive resin paste in which an electrically conductive filler is dispersed in a thermosetting resin as a base resin functioning as a resin portion is prepared. The electrically conductive resin paste is produced by stirring and mixing the thermosetting resin and the electrically conductive filler. Accordingly, the electrically conductive filler is dispersed and present in a uniform distribution in the electrically conductive resin paste. Here, the thermosetting resin is, for example, an epoxy resin. The electrically conductive filler is, for example, Ag metal powder.

Then, the electrically conductive resin paste is applied on the base electrode layer 50 by a dipping method, and heat treatment is performed at a temperature of 200° C. or higher and 550° C. or lower. Thus, the resin portion is thermally cured to form the electrically conductive resin layer 60. At this time, the atmosphere during the heat treatment is preferably an N₂ atmosphere. In order to prevent scattering of the resin and to prevent oxidation of various metal components, the oxygen concentration is preferably suppressed to 100 ppm or less.

In the present example embodiment, the dipping is performed so that the first electrically conductive resin layer 60A extends from the first end surface LS1 to a portion of the first main surface TS1 and a portion of the second main surface TS2. Further, the dipping is performed so that the second electrically conductive resin layer 60B extends from the second end surface LS2 to a portion of the first main surface TS1 and a portion of the second main surface TS2. At this time, the dipping is preferably performed so that the first electrically conductive resin layer 60A extends to a portion of the first lateral surface WS1 and a portion of the second lateral surface WS2. Further, it is preferable that the dipping is performed so that the second electrically conductive resin layer 60B extends to a portion of the first lateral surface WS1 and a portion of the second lateral surface WS2.

Then, a plated layer 70 is formed on the surface of the electrically conductive resin layer 60. In the present example embodiment, the Ni plated layer 71 and the Sn plated layer 72 are formed on the electrically conductive resin layer 60. The Ni plated layer 71 and the Sn plated layer 72 are sequentially formed by using an electrolytic plating method. As a plating method, for example, barrel plating is preferably used.

Here, in order to obtain the above-described stepped portion in each main surface-side external electrode and each lateral surface-side external electrode of the external electrode 40 as in the example embodiment, for example, the following method is exemplified.

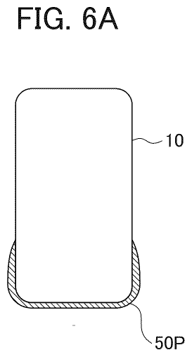

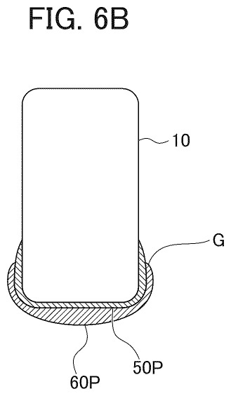

FIGS. 6A and 6B schematically illustrate a step of forming the base electrode layer 50 and the electrically conductive resin layer 60 in the method. As shown in FIG. 6A, a base electrode paste 50P functioning as the base electrode layer 50 is applied to an end portion of the multilayer body 10 in the length direction L by dipping. Next, an electrically conductive resin paste 60P functioning as the electrically conductive resin layer 60 is applied by dipping. Here, the electrically conductive resin paste 60P is applied shallower than the base electrode paste 50P. Thus, a stepped portion G is formed in the vicinity of the end portion of the electrically conductive resin paste 60P. The stepped portion G becomes the main surface-side stepped portion 800 and the lateral surface-side stepped portion 900 described above. Thereafter, the Ni plated layer 71 and the Sn plated layer 72 are formed. The Ni plated layer 71 and the Sn plated layer 72 are sequentially formed using an electrolytic plating method. As a plating method, for example, barrel plating is preferably used.

The stepped portion can also be formed by appropriately adjusting the viscosity of the base electrode paste 50P and the electrically conductive resin paste 60P, controlling the surface roughness of the base electrode layer 50, and devising a dipping method. In addition, the thickness of the plating can be adjusted by forming a surface on which the base electrode layer 50 is exposed from the electrically conductive resin layer 60 by the above-described dipping and adjusting the conditions of the plating method.

Through the above manufacturing steps, the multilayer ceramic capacitor 1 is manufactured.

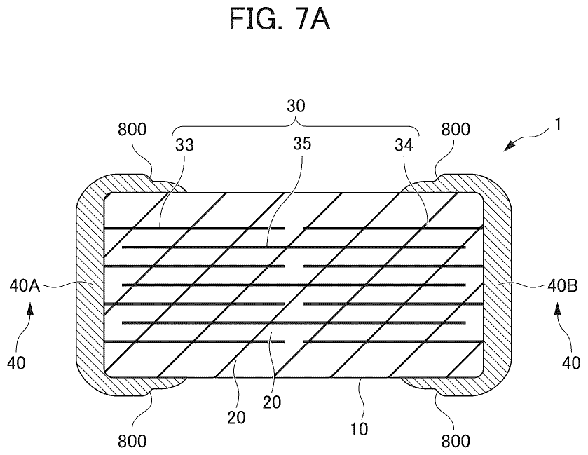

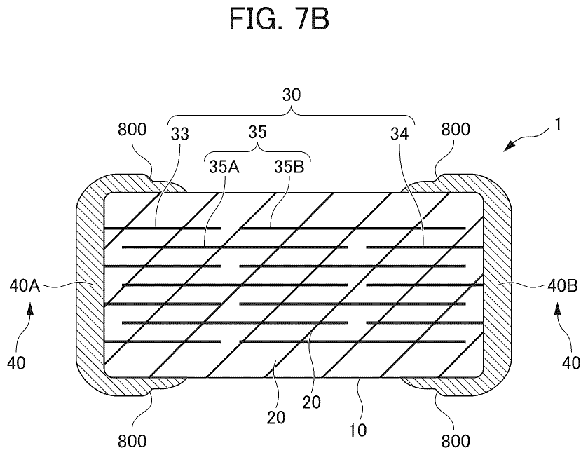

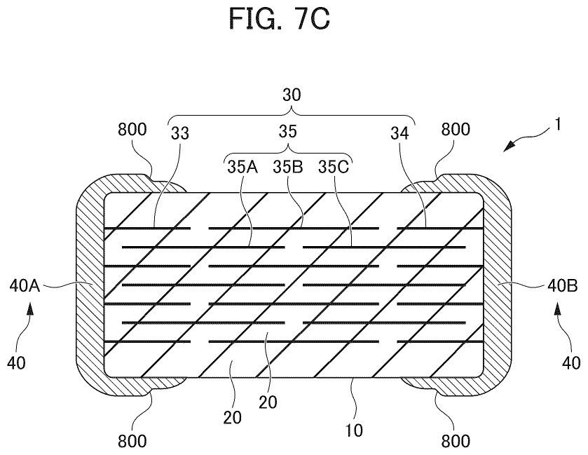

The configuration of the multilayer ceramic capacitor 1 is not limited to the configurations shown in FIGS. 1A to 4. For example, the multilayer ceramic capacitor 1 may be a multilayer ceramic capacitor including a two-portion configuration, a three-portion configuration, or a four-portion configuration as shown in FIGS. 7A, 7B, and 7C.

The multilayer ceramic capacitor 1 shown in FIG. 7A is a multilayer ceramic capacitor 1 having a two-portion structure, and includes, as internal electrode layers 30, floating internal electrode layers 35 which are not exposed at either the first end surface LS1 or the second end surface LS2 in addition to the first internal electrode layers 33 and the second internal electrode layers 34.

The multilayer ceramic capacitor 1 shown in FIG. 7B is a multilayer ceramic capacitor 1 having a three-portion structure including first floating internal electrode layers 35A and second floating internal electrode layers 35B as floating internal electrode layers 35.

The multilayer ceramic capacitor 1 shown in FIG. 7C is a multilayer ceramic capacitor 1 having a four-portion structure including first floating internal electrode layers 35A, second floating internal electrode layers 35B, and third floating internal electrode layers 35C as floating internal electrode layers 35.

As described above, by providing the floating internal electrode layers 35 as the internal electrode layers 30, the multilayer ceramic capacitor 1 has a structure in which the counter electrode portions are divided into a plurality of portions. With such a configuration, a plurality of capacitor components are provided between the opposing internal electrode layers 30, and these capacitor components are connected in series. Therefore, the voltages applied to the respective capacitor components are reduced, and thus it is possible to improve the pressure resistance of the multilayer ceramic capacitor 1. In addition, the multilayer ceramic capacitor 1 of the present example embodiment may include a multiple-portion structure of four or more.

In the multilayer ceramic capacitor 1 including the configuration shown in FIGS. 7A, 7B, and 7C, as in the above-described example embodiment, the first external electrode 40A and the second external electrode 40B each include the main surface-side external electrode, and the main surface-side external electrode includes the main surface-side stepped portion 800.

Although omitted from the illustration of the multilayer ceramic capacitor 1 including the configuration shown in FIGS. 7A, 7B, and 7C, as in the above-described example embodiment, the first external electrode 40A and the second external electrode 40B each have the lateral surface-side external electrode, and the lateral surface-side external electrode includes the lateral surface-side stepped portion 900.

In particular, the multilayer ceramic capacitor 1 including the two-portion configuration, the three-portion configuration, or the four-portion configuration including the floating internal electrode layers 35 shown in FIGS. 7A to 7C is effective for use under a high voltage. However, it is preferable to apply shrinkage stress to the multilayer body 10 as a countermeasure against electrostriction under a high voltage. In order to achieve this, a configuration is adopted which includes increased plating thickness of the external electrode on the main surface and/or the lateral surface of the multilayer body 10. In such a configuration as well, by making the plated layer in the inner thin portion of the main surface-side external electrode thicker than the plated layer in the outer thick portion to increase the compressive stress due to plating, it is possible to further increase the deflection resistance. Also in the multilayer ceramic capacitor 1 including such a multiple-portion configuration, by providing the stepped portion in, for example, the main surface-side external electrode as in the example embodiment, it is possible to improve the deflection resistance as described above, and the occurrence of cracks or the like in the multilayer body 10 is reduced or prevented.

The multilayer ceramic capacitor 1 according to the example embodiments described above encompasses the following advantageous effects.

(1) The multilayer ceramic capacitor 1 as described in an example embodiment includes: the multilayer body 10 including the plurality of dielectric layers 20 functioning as ceramic layers and the plurality of internal electrode layers 30 functioning as internal conductive layers alternately laminated in the lamination direction T defined as a height direction, the pair of main surfaces TS opposed to each other in the lamination direction T, the pair of end surfaces LS opposed to each other in the length direction L orthogonal or substantially orthogonal to the lamination direction T, and the pair of lateral surfaces WS opposed to each other in the width direction W orthogonal or substantially orthogonal to the lamination direction T and the length direction L; and the pair of external electrodes 40 that are each provided on a corresponding one of both end portions in the length direction L of the multilayer body 10 in a manner spaced from each other. The pair of main surfaces TS includes the first main surface TS1 and the second main surface TS2 opposed to each other in the lamination direction T. The pair of end surfaces LS includes the first end surface LS1 and the second end surface LS2 opposed to each other in the length direction L. The pair of lateral surfaces WS includes the first lateral surface WS1 and the second lateral surface WS2 opposed to each other in the width direction W. The plurality of internal electrode layers 30 include the plurality of first internal electrode layers 31 functioning as first internal conductive layers that extend toward and are exposed at the first end surface LS1 and the plurality of second internal electrode layers 32 functioning as second internal conductive layers that extend toward and are exposed at the second end surface LS2. Each of the pair of external electrodes 40 includes a main surface-side external electrode on at least one of the first main surface TS1 or the second main surface TS2. The main surface-side external electrode includes a surface opposed to the at least one of the first main surface TS1 or the second main surface TS2. The surface includes the stepped portion 800 that, in a height from the at least one of the first main surface TS1 or the second main surface TS2 to the surface, makes a height of the surface located adjacent to a middle of the multilayer body 10 in the length direction L lower than the surface located adjacent to an outer side of the multilayer body 10 in the length direction L. The stepped portion 800 includes a curved shape protruding toward the middle in the length direction L, and extends in the width direction W on the surface.

With such a configuration, when the multilayer ceramic capacitor 1 is mounted on a substrate, it is possible to improve the deflection resistance, and reduce or prevent the occurrence of cracks in the multilayer body 10.

(2) In the multilayer ceramic capacitor 1 as described in the example embodiment, each of the pair of external electrodes 40 includes, at an end portion thereof that is located adjacent to the middle in the length direction L of the multilayer body 10, the edge 411eA that includes a curved shape that protrudes toward the middle in the length direction L, and extends toward the width direction W, and the edge 411eA includes a curvature smaller than a curvature of the stepped portion 800.

With such a configuration, when the multilayer ceramic capacitor 1 is mounted on a substrate, it is possible to improve the deflection resistance, and reduce or prevent the occurrence of cracks in the multilayer body 10.

(3) In the multilayer ceramic capacitor 1 as described in the example embodiment, the main surface-side external electrode 411A includes the base electrode layer 50 on the at least one of the first main surface TS1 or the second main surface TS2, the plated layer 70 provided as an upper layer of the base electrode layer 50, and the electrically conductive resin layer 60 provided between the base electrode layer 50 and the plated layer 70, and at a location adjacent to the middle of the multilayer body 10 in the length direction L relative to the stepped portion 800, the plated layer 70 is provided 50 but the electrically conductive resin layer 60 is not provided, on the base electrode layer.

With such a configuration, it is possible to reduce the amount of the electrically conductive resin layer 60, and accordingly, it is possible to reduce or prevent a dimensional increase of the external electrode 40.

(4) In the multilayer ceramic capacitor 1 as described in the example embodiment, the plated layer 70 located adjacent to the middle of the multilayer body 10 in the length direction L relative to the stepped portion 800 includes the thickness H4 larger than the thickness H3 of the plated layer 70 located on an outer side of the multilayer body 10 in the length direction L relative to the stepped portion 800.

With such a configuration, it is possible to increase the compressive stress due to plating, and it is possible to improve the deflection resistance. In addition, since a portion including a large plating thickness is provided, it is possible to improve the mountability of the substrate.

In the multilayer ceramic capacitor 1 of the example embodiments, each of the first external electrode 40A and the second external electrode 40B may include the lateral surface-side external electrode, and the lateral surface-side external electrode may also include a configuration including a stepped portion similar to that of the main surface-side external electrode.

In other words, the multilayer ceramic capacitor 1 as described in an example embodiment includes: the multilayer body 10 including the plurality of dielectric layers 20 functioning as ceramic layers and the plurality of internal electrode layers 30 functioning as internal conductive layers alternately laminated in the lamination direction T defined as a height direction, the pair of main surfaces TS opposed to each other in the lamination direction T, the pair of end surfaces LS opposed to each other in the length direction L orthogonal or substantially orthogonal to the lamination direction T, and the pair of lateral surfaces WS opposed to each other in the width direction W orthogonal or substantially orthogonal to the lamination direction T and the length direction L; and the pair of external electrodes 40 that are each provided on a corresponding one of both end portions in the length direction L of the multilayer body 10 in a manner spaced apart from each other. The pair of main surfaces TS include the first main surface TS1 and the second main surface TS2 opposed to each other in the lamination direction T. The pair of end surfaces LS include the first end surface LS1 and the second end surface LS2 opposed to each other in the length direction L. The pair of lateral surfaces WS include the first lateral surface WS1 and the second lateral surface WS2 opposed to each other in the width direction W. The plurality of internal electrode layers 30 include the plurality of first internal electrode layers 31 functioning as first internal conductive layers that extend toward and are exposed at the first end surface LS1 and the plurality of second internal electrode layers 32 functioning as second internal conductive layers that extend toward and are exposed at the second end surface LS2. Each of the pair of external electrodes 40 includes a lateral surface-side external electrode on at least one of the first lateral surface WS1 or the second lateral surface WS2. The lateral surface-side external electrode includes a surface opposed to the at least one of the first lateral surface WS1 or the second lateral surface WS2. The surface includes the stepped portion that, in a height from the at least one of the first lateral surface WS1 or the second lateral surface WS2 to the surface, makes a height of the surface located adjacent to a middle of the multilayer body 10 in the length direction L lower than the surface located adjacent to an outer side of the multilayer body 10 in the length direction L. The stepped portion includes a curved shape protruding toward the middle in the length direction L, and extends in the width direction W on the surface.

The present invention is not limited to the configurations of the above-described example embodiments, and can be applied by appropriately modifying in a scope not changing the gist of the present invention. In addition, a combination of two or more of the individual desirable configurations described in the above example embodiments is also included in the present invention.

For example, the multilayer ceramic capacitor 1 may be a two-terminal type including two external electrodes or a multi-terminal type including a large number of external electrodes.

In the above-described example embodiments, a multilayer ceramic capacitor including a dielectric ceramic is exemplified as the multilayer ceramic electronic component. However, the multilayer ceramic electronic component of the present disclosure is not limited thereto, and is also applicable to various multilayer ceramic electronic components such as a piezoelectric component including a piezoelectric ceramic, a thermistor including a semiconductor ceramic, and an inductor including a magnetic ceramic. Examples of the piezoelectric ceramic include lead zirconate titanate (PZT) ceramics, examples of the semiconductor ceramic include spinel ceramics, and examples of the magnetic ceramic include ferrites.

Although the external electrode 40 of the example embodiments includes the electrically conductive resin layer 60, the external electrode 40 may not necessarily include the electrically conductive resin layer 60.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic electronic component comprising:
a multilayer body including a plurality of ceramic layers and a plurality of internal conductive layers alternately laminated in a height direction, a pair of main surfaces opposed to each other in the height direction, a pair of end surfaces opposed to each other in a length direction orthogonal or substantially orthogonal to the height direction, and a pair of lateral surfaces opposed to each other in a width direction orthogonal or substantially orthogonal to the height direction and the length direction; and
a pair of external electrodes that are each provided on a corresponding one of both end portions in the length direction of the multilayer body in a manner spaced apart from each other, wherein
the pair of main surfaces includes a first main surface and a second main surface opposed to each other in the height direction,
the pair of end surfaces includes a first end surface and a second end surface opposed to each other in the length direction,
the pair of lateral surfaces includes a first lateral surface and a second lateral surface opposed to each other in the width direction,
the plurality of internal conductive layers include a plurality of first internal conductive layers that extend toward and are exposed at the first end surface and a plurality of second internal conductive layers that extend toward and are exposed at the second end surface,
each of the pair of external electrodes includes a main surface-side external electrode on at least one of the first main surface or the second main surface,
the main surface-side external electrode includes a surface opposed to the at least one of the first main surface or the second main surface,
the surface includes a stepped portion that, in a height from the at least one of the first main surface or the second main surface to the surface, makes a height of the surface located adjacent to a middle of the multilayer body in the length direction lower than the surface located adjacent to an outer side of the multilayer body in the length direction, and
the stepped portion includes a curved shape protruding toward the middle in the length direction, and extends in the width direction on the surface.

2. The multilayer ceramic electronic component according to claim 1, wherein
each of the pair of external electrodes includes, at an end portion thereof that is located adjacent to the middle in the length direction, an edge that includes a curved shape that protrudes toward the middle in the length direction, and extends toward the width direction, and
the edge includes a curvature smaller than a curvature of the stepped portion.

3. The multilayer ceramic electronic component according to claim 1, wherein
the main surface-side external electrode includes a base electrode layer on the at least one of the first main surface or the second main surface, a plated layer provided as an upper layer of the base electrode layer, and an electrically conductive resin layer provided between the base electrode layer and the plated layer, and
at a location adjacent to the middle of the multilayer body in the length direction relative to the stepped portion, the plated layer is provided and the electrically conductive layer is not provided, on the base electrode layer.

4. The multilayer ceramic electronic component according to claim 3, wherein the plated layer located adjacent to the middle of the multilayer body in the length direction relative to the stepped portion includes a thickness larger than a thickness of the plated layer located on an outer side of the multilayer body in the length direction relative to the stepped portion.
